(19) United States
(12) Patent Application Publication
(10) Pub. No.: US 2026/0128226 A1
(43) Pub. Date: May 7, 2026

(54) MULTILAYER CERAMIC CAPACITOR

(71) Applicant: Murata Manufacturing Co., Ltd., Nagaokakyo-shi (JP)

(72) Inventor: Kosuke ONISHI, Nagaokakyo-shi (JP)

(21) Appl. No.: 19/437,426

(22) Filed: Dec. 31, 2025

Related U.S. Application Data
(63) Continuation of application No. PCT/JP2024/013800, filed on Apr. 3, 2024.

(30) Foreign Application Priority Data
Jul. 21, 2023 (JP) 2023-119009
Dec. 5, 2023 (JP) 2023-205232

(51) Int. Cl. H01G 4/30; H01G 4/012; H01G 4/232

(52) U.S. Cl. CPC H01G 4/30; H01G 4/012; H01G 4/232

(57) ABSTRACT

A multilayer ceramic capacitor includes dielectric layers, inner electrode layers, first and second main surfaces facing each other in a lamination direction, first and second side surfaces facing each other in a width direction, and first and second end surfaces facing each other in a length direction, a first outer electrode on the first main surface and the first end surface, and a second outer electrode on the first main surface and the second end surface, the first and second end surfaces include inclined surfaces splayed out from the first main surface toward the second main surface and including a first inclined portion on the first main surface side and a second inclined portion on the second main surface side, and an inclination angle of the first inclined portion to the length direction is different from an inclination angle of the second inclined portion to the length direction.

### CROSS REFERENCE TO RELATED APPLICATIONS

This application claims the benefit of priority to Japanese Patent Application No. 2023-205232 filed on Dec. 5, 2023 and Japanese Patent Application No. 2023-119009 filed on Jul. 21, 2023, and is a Continuation Application of PCT Application No. PCT/JP2024/013800 filed on Apr. 3, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Electronic devices such as a mobile phone and a portable music player have recently become increasingly smaller and thinner. Accordingly, multilayer ceramic electronic components such as a multilayer ceramic capacitor installed in such a smaller and thinner electronic device have also become smaller and thinner. Particularly, multilayer ceramic electronic components that are becoming thinner are increasingly being used, for example, embedded in a wiring board, or being mounted in a very narrow space even when mounted on the surface of the wiring board. As such, the thinner the multilayer ceramic electronic components, the lower the mechanical strength thereof, leading to a strong demand for securing the mechanical strength.

For example, Japanese Unexamined Patent Application Publication No. 2012-222276 discloses a thin multilayer capacitor. This multilayer capacitor includes a capacitor main body having a substantially rectangular parallelepiped shape, a first outer electrode that continuously covers a front surface and front portions of left and right surfaces and upper and lower surfaces of the capacitor main body, and a second outer electrode that continuously covers a rear surface and rear portions of the left and right surfaces and upper and lower surfaces of the capacitor main body. This multilayer capacitor is a thin multilayer capacitor having a dimension H of 0.15 mm in a height direction.

### SUMMARY OF THE INVENTION

In such a thin multilayer capacitor, the contact area between a multilayer body and the outer electrodes is reduced. Therefore, in a case of mounting using a first main surface of the multilayer capacitor as a mounting surface, solder contraction stress upon mounting acts on the outer electrodes, causing the outer electrodes to easily peel off from the multilayer body.

Example embodiments of the present invention provide multilayer ceramic capacitors each capable of improving a fixing strength between a multilayer body and outer electrodes.

A multilayer ceramic capacitor according to an example embodiment of the present invention includes a multilayer body including a plurality of laminated dielectric layers, a plurality of inner electrode layers laminated on the dielectric layers, a first main surface and a second main surface facing each other in a lamination direction of the plurality of dielectric layers, a first side surface and a second side surface facing each other in a width direction orthogonal to the lamination direction, and a first end surface and a second end surface facing each other in a length direction orthogonal to the lamination direction and the width direction, a first outer electrode on the first main surface and the first end surface of the multilayer body, and a second outer electrode on the first main surface and the second end surface of the multilayer body, the first end surface and the second end surface include inclined surfaces splayed out from the first main surface toward the second main surface, the inclined surfaces include a first inclined portion on the first main surface side and a second inclined portion on the second main surface side, and an inclination angle of the first inclined portion with respect to the length direction is different from an inclination angle of the second inclined portion with respect to the length direction.

In a multilayer ceramic capacitor according to an example embodiment of the present invention, the first end surface and the second end surface include inclined surfaces splayed out from the first main surface toward the second main surface. The inclined surfaces include a first inclined portion on the first main surface side and a second inclined portion on the second main surface side. The inclination angle of the first inclined portion with respect to the length direction is different from the inclination angle of the second inclined portion with respect to the length direction. This allows stress near the intersection of the second main surface and the first end surface and stress near the intersection of the second main surface and the second end surface, where the first outer electrode and the second outer electrode are easily peeled off from the multilayer body upon mounting with the first main surface as the mounting surface, to be dispersed to the vicinity of the second inclined portion. Thus, the effect of reducing or preventing the peeling of the first outer electrode and the second outer electrode from the multilayer body can be achieved.

Example embodiments of the present invention provide multilayer ceramic capacitors each capable of improving fixing strength between the multilayer body and the outer electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to a first example embodiment of the present invention.

FIG. 2 is a plan view illustrating an example of the multilayer ceramic capacitor according to the first example embodiment of the present invention.

FIG. 3 is a front view illustrating an example of the multilayer ceramic capacitor according to the first example embodiment of the present invention.

FIG. 4 is a side view illustrating an example of the multilayer ceramic capacitor according to the first example embodiment of the present invention.

FIG. 5 is a schematic sectional view taken along line V-V in FIG. 1.

FIG. 6 is a schematic sectional view taken along line VI-VI in FIG. 1.

FIG. 7 is a schematic sectional view taken along line VII-VII in FIG. 1.

FIG. 8A is an external perspective view of a multilayer body of the multilayer ceramic capacitor according to the first example embodiment of the present invention, and FIG. 8B is an external perspective view of the multilayer body as viewed from a different direction from FIG. 8A.

FIG. 9 is a schematic sectional view illustrating an example of a multilayer ceramic capacitor according to a first modification of the first example embodiment of the present invention.

FIG. 10 is a schematic sectional view illustrating an example of a multilayer ceramic capacitor according to a second modification of the first example embodiment of the present invention.

FIG. 11 is a schematic sectional view illustrating an example of a multilayer ceramic capacitor according to a third modification of the first example embodiment of the present invention.

FIG. 12 is a schematic sectional view illustrating an example of a multilayer ceramic capacitor according to a fourth modification of the first example embodiment of the present invention.

FIG. 13 is a schematic sectional view illustrating an example of a multilayer ceramic capacitor according to a fifth modification of the first example embodiment of the present invention.

FIG. 14 is a schematic sectional view illustrating an example of a multilayer ceramic capacitor according to a sixth modification of the first example embodiment of the present invention.

FIG. 15 is an external perspective view illustrating an example of a multilayer ceramic capacitor according to a second example embodiment of the present invention.

FIG. 16 is an external perspective view illustrating an example of the multilayer ceramic capacitor according to the second example embodiment of the present invention.

FIG. 17 is a front view illustrating an example of the multilayer ceramic capacitor according to the second example embodiment of the present invention.

FIG. 18 is a side view illustrating an example of the multilayer ceramic capacitor according to the second example embodiment of the present invention.

FIG. 19 is a schematic sectional view taken along line XIX-XIX in FIG. 15.

FIG. 20 is a schematic sectional view taken along line XX-XX in FIG. 15.

FIG. 21 is a schematic sectional view taken along line XXI-XXI in FIG. 15.

FIG. 22 is a schematic sectional view taken along line XXII-XXII in FIG. 15.

FIG. 23A is an external perspective view of a multilayer body of the multilayer ceramic capacitor according to the second example embodiment of the present invention, and FIG. 23B is an external perspective view of the multilayer body as viewed from a different direction from FIG. 23A.

FIG. 24 is an external perspective view illustrating an example of a multilayer ceramic capacitor according to a third example embodiment of the present invention.

FIG. 25 is a schematic sectional view taken along line XXV-XXV in FIG. 24, illustrating a structure of an example of the multilayer ceramic capacitor according to the third example embodiment of the present invention.

FIG. 26 is a schematic sectional view taken along line XXVI-XXVI in FIG. 24, illustrating a structure of an example of the multilayer ceramic capacitor according to the third example embodiment of the present invention.

### DETAILED DESCRIPTION OF THE EXAMPLE EMBODIMENTS

Example embodiments of multilayer ceramic capacitors will be described below as an example of the present invention.

An example of a multilayer ceramic capacitor 10 according to an example embodiment of the present invention will be described.

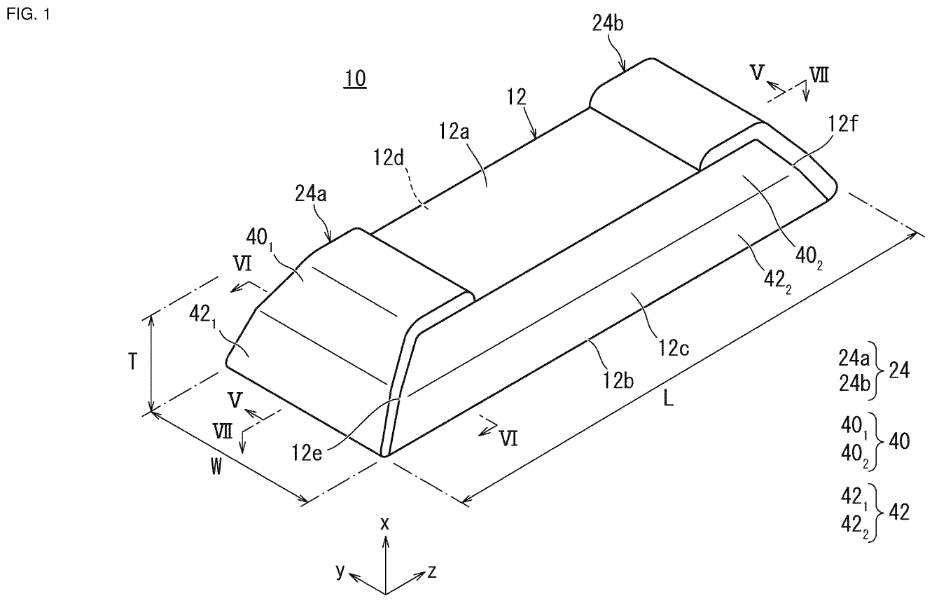

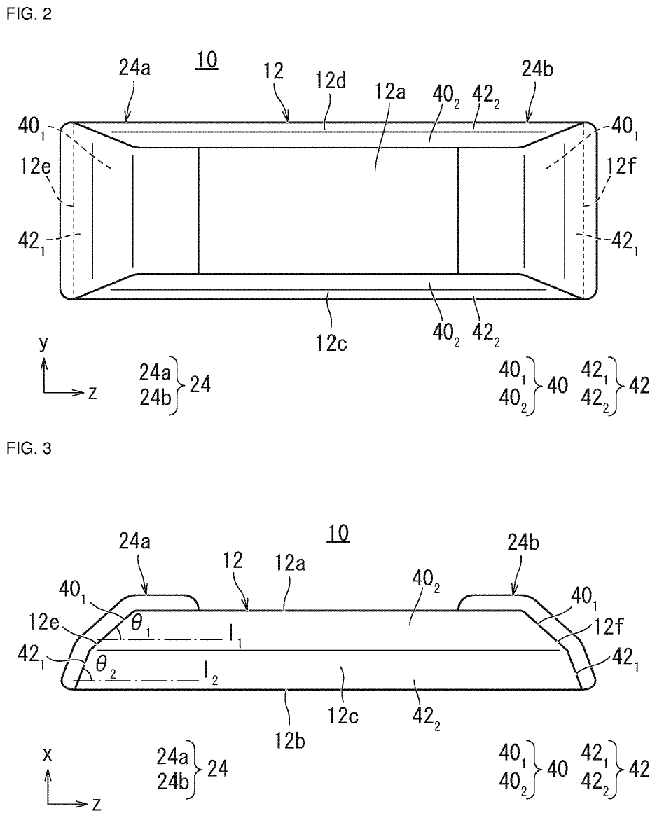

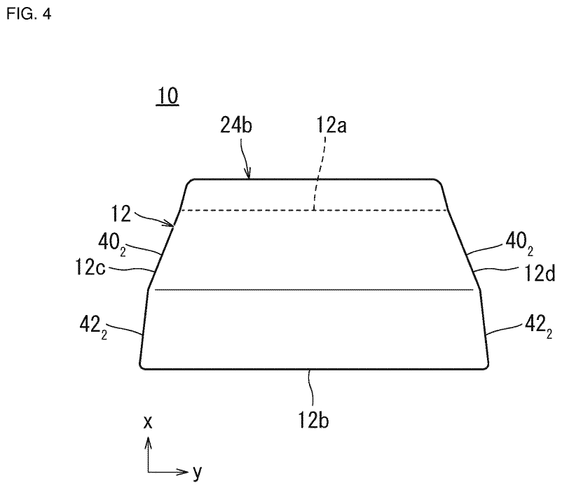

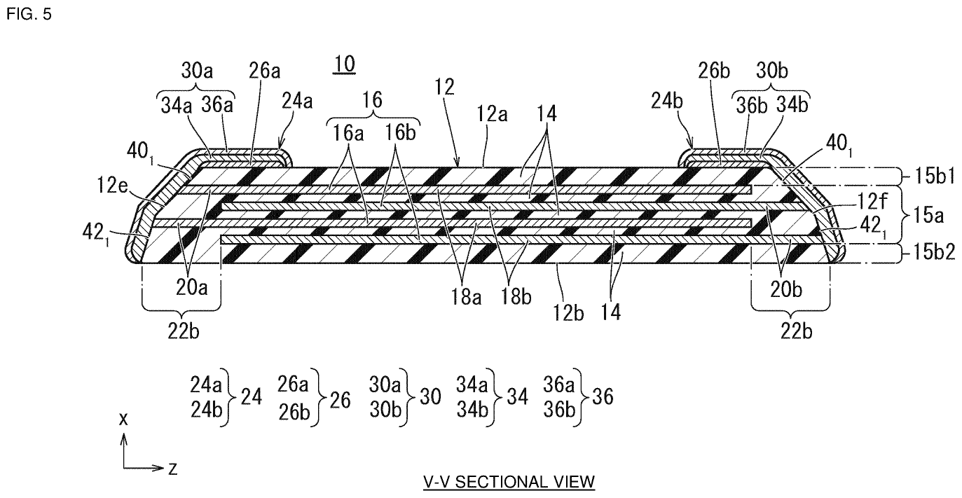

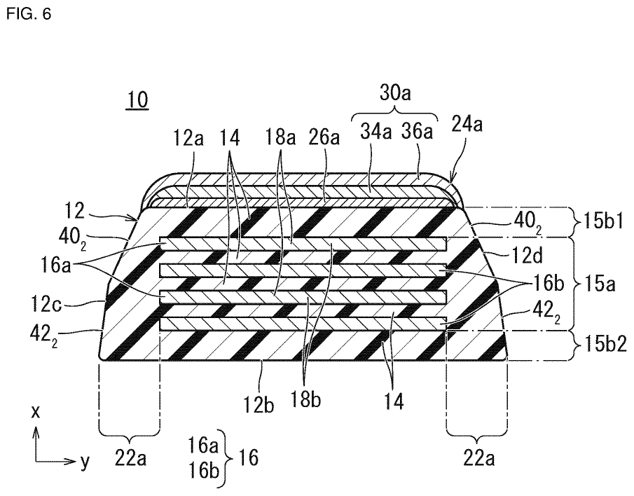

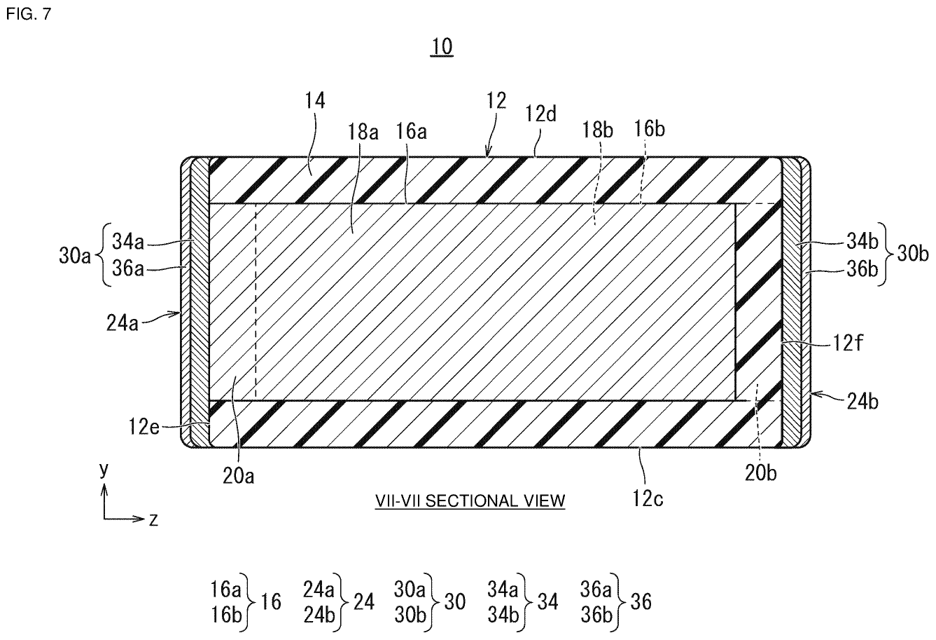

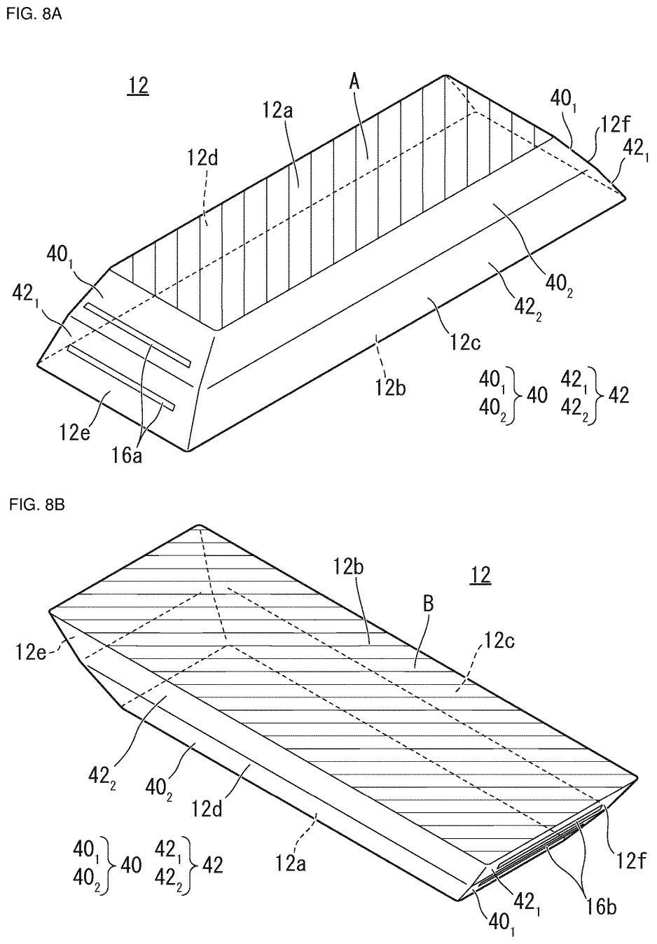

FIG. 1 is an external perspective view illustrating an example of a multilayer ceramic capacitor according to a first example embodiment of the present invention. FIG. 2 is a plan view illustrating an example of the multilayer ceramic capacitor according to the first example embodiment of the present invention. FIG. 3 is a front view illustrating an example of the multilayer ceramic capacitor according to the first example embodiment of the present invention. FIG. 4 is a side view illustrating an example of the multilayer ceramic capacitor according to the first example embodiment of the present invention. FIG. 5 is a schematic sectional view taken along line V-V in FIG. 1. FIG. 6 is a schematic sectional view taken along line VI-VI in FIG. 1. FIG. 7 is a schematic sectional view taken along line VII-VII in FIG. 1. FIG. 8A is an external perspective view of a multilayer body of the multilayer ceramic capacitor according to the first example embodiment of the present invention. FIG. 8B is an external perspective view of the multilayer body as viewed from a different direction from FIG. 8A.

The multilayer ceramic capacitor 10 includes a multilayer body 12 and an outer electrode 24. Hereinafter, configurations of the multilayer body 12 and the outer electrode 24 will be described in this order.

The multilayer body 12 includes a first main surface 12a and a second main surface 12b facing each other in a height direction x that is the lamination direction of a plurality of dielectric layers 14, a first side surface 12c and a second side surface 12d facing each other in a width direction y orthogonal to the height direction x, and a first end surface 12e and a second end surface 12f facing each other in a length direction z orthogonal to the height direction x and the width direction y.

The multilayer body 12 includes rounded corner and ridge portions. The corner portion refers to the intersection of three adjacent surfaces of the multilayer body 12. The ridge portion refers to the intersection of two adjacent surfaces of the multilayer body 12. Furthermore, unevenness or the like may be present on a portion of or an entirety of the first main surface 12a and the second main surface 12b, the first side surface 12c and the second side surface 12d, and the first end surface 12e and the second end surface 12f.

It is preferable that the first main surface 12a and/or the second main surface 12b be flat. A flat surface allows the stress received from a nozzle for picking up the multilayer ceramic capacitor 10 to be dispersed across the flat surface, thus improving the strength of the multilayer ceramic capacitor 10 upon mounting. The multilayer ceramic capacitor 10 according to this example embodiment includes the second main surface 12b that is flat.

As illustrated in FIGS. 5 and 6, the multilayer body 12 includes, in the height direction x connecting the first main surface 12a to the second main surface 12b an inner layer portion 15a in which a plurality of inner electrode layers 16 face each other, a first main surface-side outer layer portion 15b1 including a plurality of dielectric layers 14 located between the first main surface 12a and the inner electrode layer 16 located closest to the first main surface 12a, and a second main surface-side outer layer portion 15b2 including a plurality of dielectric layers 14 located between the second main surface 12b and the inner electrode layer 16 located closest to the second main surface 12b.

The first main surface-side outer layer portion 15b1 and the second main surface-side outer layer portion 15b2 may become integrated after baking and cannot be distinguishable from one another, but are an aggregate of a plurality of outer dielectric layers.

The first main surface-side outer layer portion 15b1 is located on the first main surface 12a side of the multilayer body 12 and is an aggregate of a plurality of dielectric layers 14 located between the first main surface 12a and the inner electrode layer 16 closest to the first main surface 12a.

The second main surface-side outer layer portion 15b2 is located on the second main surface 12b side of the multilayer body 12 and is an aggregate of a plurality of dielectric layers 14 located between the second main surface 12b and the inner electrode layer 16 closest to the second main surface 12b.

The dimensions of the multilayer body 12 are not particularly limited, but it is preferable that the dimension in the length direction z be about 0.1 mm to about 1.6 mm, inclusive, the dimension in the width direction y be about 0.1 mm to about 1.6 mm, inclusive, and the dimension in the height direction x be about 0.01 mm to about 0.1 mm, inclusive, for example.

The dielectric layer 14 may include a dielectric material, for example. The dielectric material may include a plurality of crystal grains including a perovskite compound with a basic structure of BaTiO₃, for example. As a specific material of the dielectric layer 14, dielectric ceramics mainly including CaTiO₃, SrTiO₃, CaZrO₃ or the like, besides BaTiO₃, can be used. Depending on the desired characteristics of the multilayer body, it is also possible to use a material including a smaller amount of subcomponent than the main component such as Mn compound, Fe compound, Cr compound, Co compound, or Ni compound.

The outer dielectric layer may include a plurality of crystal grains including a perovskite compound with a basic structure of BaTiO₃, for example. For example, dielectric ceramics mainly including BaTiO₃, CaTiO₃, SrTiO₃, CaZrO₃ or the like can be used. Alternatively, subcomponents such as Mn compound, Fe compound, Cr compound, Co compound, or Ni compound may also be added to these main components. The materials of the dielectric layer 14 and the outer dielectric layer may be different depending on the desired functions. For example, a soft outer dielectric layer can buffer stress on the multilayer body, while a hard outer dielectric layer can reduce or prevent the occurrence of cracks.

The first main surface-side outer layer portion 15b1 preferably has a thickness of about 2 μm to about 15 μm, inclusive, for example. The second main surface-side outer layer portion 15b2 preferably has a thickness of about 2 μm to about 15 μm, inclusive, for example.

The first end surface 12e and the second end surface 12f include inclined surfaces that are inclined so as to splay out from the first main surface 12a toward the second main surface 12b. The first side surface 12c and the second side surface 12d also include inclined surfaces that are inclined so as to splay out from the first main surface 12a toward the second main surface 12b. The first side surface 12c and the second side surface 12d do not have to be inclined so as to splay out from the first main surface 12a toward the second main surface 12b.

In other words, in the multilayer body 12, the length of the first main surface 12a in the length direction z is shorter than the length of the second main surface 12b in the length direction z. Therefore, as illustrated in FIG. 3, the multilayer body 12 has a substantially trapezoidal shape in side view. Furthermore, in the multilayer body 12, the length of the first main surface 12a in the width direction y is preferably shorter than the length of the second main surface 12b in the width direction y. As a result, as illustrated in FIG. 4, the multilayer body 12 has a substantially trapezoidal shape in end view.

Therefore, in the multilayer body 12, if the length of the first main surface 12a in the length direction z is shorter than the length of the second main surface 12b in the length direction z and the length of the first main surface 12a in the width direction y is shorter than the length of the second main surface 12b in the width direction y, the condition A<B is satisfied in the lamination direction of the multilayer body 12, as illustrated in FIGS. 8A and 8B, where A is the area of the first main surface 12a and B is the area of the second main surface 12b.

The multilayer body 12 includes a first inclined portion 40 and a second inclined portion 42 in the inclined surface that is inclined from the first main surface 12a toward the second main surface 12b.

The first inclined portion 40 includes a first inclined portion 40₁ on the first main surface 12a side in the first end surface 12e and the second end surface 12f, and a first inclined portion 40₂ on the first main surface 12a side in the first side surface 12c and the second side surface 12d.

The second inclined portion 42 includes a second inclined portion 42₁ on the second main surface 12b side in the first end surface 12e and the second end surface 12f, and a second inclined portion 42₂ on the second main surface 12b side in the first side surface 12c and the second side surface 12d.

Note that the inclined surfaces of the first side surface 12c and the second side surface 12d do not have to have the first inclined portion 40₂ and the second inclined portion 42₂.

The first inclined portion 40₁ and the second inclined portion 42₁ are formed continuously. This can improve the adhesion between the multilayer body 12 and the outer electrode 24 compared to a case where the first inclined portion 40₁ and the second inclined portion 42₁ are formed discontinuously. Furthermore, the first inclined portion 40₂ and the second inclined portion 42₂ are formed continuously.

Note that the first inclined portion 40₁ and the second inclined portion 42₁ may be formed discontinuously, and the first inclined portion 40₂ and the second inclined portion 42₂ may be formed discontinuously.

The first inclined portion 40₁ and the second inclined portion 42₁ are polished in the width direction y to about ¼ W or about ½ W of the dimension of the multilayer ceramic capacitor 10, for example, and the cross-section is observed with a scanning electron microscope (SEM, for example, manufactured by JEOL Ltd.) at a magnification of 3000× and a square of 50 μm. From the observed image of the cross-section thus obtained, the inclined portions formed in the first end surface 12e or the second end surface 12f are designated as the first inclined portion 40₁ and the second inclined portion 42₁.

Similarly, the first inclined portion 40₂ and the second inclined portion 42₂ are polished in the length direction z to about ¼ L or about ½ L of the dimension of the multilayer ceramic capacitor 10, for example, and the cross-section is observed with the scanning electron microscope (SEM, for example, manufactured by JEOL Ltd.) at a magnification of 3000× and a square of 50 μm. From the observed image of the cross-section thus obtained, the inclined portions formed in the first end surface 12e or the second end surface 12f are designated as the first inclined portion 40₂ and the second inclined portion 42₂.

As illustrated in FIG. 3, an inclination angle θ₁ between the first inclined portion 40₁ and a line l₁ parallel to the length direction z is different from an inclination angle θ₂ between the second inclined portion 42₁ and a line l₂ parallel to the length direction z.

This allows stress near the intersection of the second main surface 12b and the first end surface 12e and stress near the intersection of the second main surface 12b and the second end surface 12f, where the outer electrode 24 is easily peeled off from the multilayer body 12 upon mounting with the first main surface 12a as the mounting surface, to be dispersed to the vicinity of the inclined portions, thus achieving the effect of reducing or preventing the peeling of the outer electrode 24.

The inclination angle θ₂ between the second inclined portion 42₁ and the line l₂ parallel to the length direction z is preferably greater than the inclination angle θ₁ between the first inclined portion 40₁ and the line l₁ parallel to the length direction z.

Furthermore, the inclination angle θ₁ between the first inclined portion 40₁ and the line l₁ parallel to the length direction z is preferably about 30° to about 85°, inclusive, for example. If the inclination angle θ₁ is smaller than about 30°, it becomes difficult to achieve an angular difference between the inclination angle θ₁ of the first inclined portion 40₁ and the inclination angle θ₂ of the second inclined portion 42₁. On the other hand, if the inclination angle θ₁ is greater than about 85°, it becomes difficult to achieve the peeling suppression effect.

The inclination angle θ₂ between the second inclined portion 42₁ and the line l₂ parallel to the length direction z is preferably greater than the inclination angle θ₁ between the first inclined portion 40₁ and the line l₁ parallel to the length direction z by about 5° or more, for example. By making the second inclined portion 42₁ larger than the first inclined portion 40₁, a chip distance in the length direction z is shortened, making it possible to reduce the force acting on the electrode end due to the leverage principle of stress during solder contraction. On the other hand, if the difference between the inclination angle θ₂ between the second inclined portion 42₁ and a line parallel to the length direction z and the inclination angle θ₁ between the first inclined portion 40₁ and a line parallel to the length direction z is less than 5°, it becomes difficult to achieve the peeling suppression effect.

On the first end surface 12e and the second end surface 12f, the inner electrode layer 16 may be exposed at the first inclined portion 40₁. Exposing the inner electrode layer 16 at the first inclined portion 40₁ ensures close metal-to-metal contact between the inner electrode layer 16 and the outer electrode 24, improving the fixing strength between the multilayer body 12 and the outer electrode 24.

On the first end surface 12e and the second end surface 12f, the inner electrode layer 16 may be exposed at the second inclined portion 42₁. Exposing the inner electrode layer 16 at the second inclined portion 42₁ ensures close metal-to-metal contact between the inner electrode layer 16 and the outer electrode 24, improving the fixing strength between the multilayer body 12 and the outer electrode 24.

The number of dielectric layers 14 to be laminated is not particularly limited, but is preferably 3 to 700, inclusive, in total, for example, including the inner layer portion 15a, the first main surface-side outer layer portion 15b1, and the second main surface-side outer layer portion 15b2. Furthermore, the inner layer portion 15a preferably has a thickness of about 0.4 μm to about 2.0 μm, inclusive, for example. The first main surface-side outer layer portion 15b1 and the second main surface-side outer layer portion 15b2 each preferably have a thickness of about 2.0 μm to about 10.0 μm, inclusive, for example.

As illustrated in FIGS. 5 and 6, the inner electrode layer 16 includes first inner electrode layers 16a and second inner electrode layers 16b. The first inner electrode layers 16a and the second inner electrode layers 16b are alternately laminated with the dielectric layers 14 interposed therebetween.

The first inner electrode layer 16a is located on the surface of the dielectric layer 14. The first inner electrode layer 16a includes a first counter electrode portion 18a facing the second inner electrode layer 16b, and a first extended electrode portion 20a located on one end side of the first inner electrode layer 16a and extended from the first counter electrode portion 18a to the first end surface 12e of the multilayer body 12. The first extended electrode portion 20a has its end portion extended and exposed to the first end surface 12e.

The shape of the first counter electrode portion 18a of the first inner electrode layer 16a is not particularly limited, but is preferably rectangular in or substantially rectangular plan view. However, the corners in plan view may be rounded or the corners may be at an angle in plan view (tapered shape). Alternatively, the shape may be a tapered shape in plan view that is inclined in either direction.

The shape of the first extended electrode portion 20a of the first inner electrode layer 16a is not particularly limited, but is preferably rectangular in or substantially rectangular plan view. However, the corners in plan view may be rounded or the corners may be at an angle in plan view (tapered shape). Alternatively, the shape may be a tapered shape in plan view that is inclined in either direction.

The width of the first counter electrode portion 18a of the first inner electrode layer 16a may be the same as the width of the first extended electrode portion 20a of the first inner electrode layer 16a, or one of the widths may be narrower.

The second inner electrode layer 16b is located on the surface of the dielectric layer 14 different from the dielectric layer 14 on which the first inner electrode layer 16a is provided. The second inner electrode layer 16b includes a second counter electrode portion 18b facing the first inner electrode layer 16a, and a second extended electrode portion 20b located on one end side of the second inner electrode layer 16b and extended from the second counter electrode portion 18b to the second end surface 12f of the multilayer body 12. The second extended electrode portion 20b has its end portion extended and exposed to the second end surface 12f.

The shape of the second counter electrode portion 18b of the second inner electrode layer 16b is not particularly limited, but is preferably rectangular in or substantially rectangular plan view. However, the corners in plan view may be rounded or the corners may be formed at an angle in plan view (tapered shape). Alternatively, the shape may be a tapered shape in plan view that is inclined in either direction.

The shape of the second extended electrode portion 20b of the second inner electrode layer 16b is not particularly limited, but is preferably rectangular in or substantially rectangular plan view. However, the corners in plan view may be rounded or the corners may be formed at an angle in plan view (tapered shape). Alternatively, the shape may be a tapered shape in plan view that is inclined in either direction.

The width of the second counter electrode portion 18b of the second inner electrode layer 16b may be the same as the width of the second extended electrode portion 20b of the second inner electrode layer 16b, or one of the widths may be narrower.

The first extended electrode portion 20a of the first inner electrode layer 16a and the second extended electrode portion 20b of the second inner electrode layer 16b may be curved toward the first main surface 12a or the second main surface 12b. Furthermore, the longest distance in the height direction x between the exposed portions of the first extended electrode portion 20a of the first inner electrode layer 16a extended to the first end surface 12e and the longest distance in the height direction x between the exposed portions of the second extended electrode portion 20b of the second inner electrode layer 16b extended to the second end surface 12f may be shorter than the longest distance in the height direction x between the first counter electrode portion 18a of the first inner electrode layer 16a and the second counter electrode portion 18b of the second inner electrode layer 16b.

The number of inner electrode layers 16 to be laminated is not particularly limited, but is preferably 2 to 700, inclusive, for example. The inner electrode layer 16 preferably has a thickness of about 0.2 μm to about 2.0 μm, inclusive, for example.

The multilayer body 12 includes side portions 22a (W gaps) of the multilayer body 12 located between the inner electrode layer 16 and the first side surface 12c and between the inner electrode layer 16 and the second side surface 12d. Furthermore, the multilayer body 12 includes end portions 22b (L gaps) of the multilayer body 12 located between the inner electrode layer 16 and the first end surface 12e and between the inner electrode layer 16 and the second end surface 12f.

The inner electrode layers 16 can be made of, but not limited to, an appropriate conductive material, such as metals such as Ni, Cu, Ag, Pd, and Au, or alloys including at least one of these metals, such as Ag-Pd alloy.

Sn included in the first inner electrode layer 16a and the second inner electrode layer 16b can alleviate the electric field concentration at the interface between the inner electrode layer 16 and the dielectric layer 14, leading to improved high-temperature load reliability. In this case, Sn can be sufficiently effective even if it is included in only one of the first inner electrode layer 16a and the second inner electrode layer 16b.

In this example embodiment, the first counter electrode portion 18a of the first inner electrode layer 16a and the second counter electrode portion 18b of the second inner electrode layer 16b face each other with the dielectric layer 14 interposed therebetween, thus generating an electrostatic capacitance and exhibiting capacitor characteristics.

In order to increase the capacitance of the capacitor, the area of the inner electrode layer 16 needs to be increased. Therefore, the inner electrode layer 16 preferably has a LW surface coverage of more than or equal to about 90%, for example. The LW surface coverage is defined as the percentage of the area inside the edge portion of the inner electrode layer 16 as viewed from the LW surface of the multilayer body 12 minus the area of any voids. The higher the LW surface coverage, the higher the capacitance of the capacitor. However, even with a lower LW surface coverage, the dielectric layers 14 are bonded with voids interposed therebetween, thus increasing the bonding strength between the layers to reduce or prevent interlayer peeling.

As illustrated in FIGS. 1 to 7, the outer electrode 24 is located on the first end surface 12e and the second end surface 12f of the multilayer body 12.

The outer electrode 24 includes a thin film layer 26 and a plating layer 30 covering the thin film layer 26.

The outer electrode 24 includes a first outer electrode 24a and a second outer electrode 24b.

The first outer electrode 24a is located on the first end surface 12e and a portion of the first main surface 12a of the multilayer body 12. In this case, the first outer electrode 24a is electrically connected to the first extended electrode portion 20a of the first inner electrode layer 16a. The first outer electrode 24a may extend slightly onto a portion of the first side surface 12c and a portion of the second side surface 12d.

The second outer electrode 24b is located on the second end surface 12f and a portion of the first main surface 12a of the multilayer body 12. In this case, the second outer electrode 24b is electrically connected to the second extended electrode portion 20b of the second inner electrode layer 16b. The second outer electrode 24b may extend slightly onto a portion of the first side surface 12c and a portion of the second side surface 12d.

The outer electrode 24 includes the thin film layer 26, an upper plating layer 34 covering the thin film layer 26, and a surface plating layer 36 covering the upper plating layer 34.

The thin film layer 26 includes a first thin film layer 26a and a second thin film layer 26b.

The first thin film layer 26a covers a portion of the first main surface 12a on the first end surface 12e side of the multilayer body 12, but does not cover the first end surface 12e of the multilayer body 12. The first thin film layer 26a may also extend around to one of the surfaces in contact with the first main surface 12a.

The second thin film layer 26b covers a portion of the first main surface 12a on the second end surface 12f side of the multilayer body 12, but does not cover the second end surface 12f of the multilayer body 12. The second thin film layer 26b may also extend around to one of the surfaces in contact with the first main surface 12a.

As described above, the first thin film layer 26a and the second thin film layer 26b are electrodes located on the first main surface 12a. The first thin film layer 26a and the second thin film layer 26b are preferably formed by deposition of metal particles using a method such as sputtering or vapor deposition. Accordingly, the thickness of the first thin film layer 26a and the second thin film layer 26b in the direction connecting the first main surface 12a and the second main surface 12b of the multilayer body 12 can be set to smaller than or equal to about 1 μm, for example, allowing the dimension in the height direction x of the multilayer ceramic capacitor 10 to be sufficiently small for height reduction.

The dimension in the height direction x of the first thin film layer 26a and the second thin film layer 26b can be measured as follows. Specifically, in a case of forming the thin film layers by depositing metal particles, a fluorescent X-ray apparatus can be used to obtain the thickness converted from the concentration of a specified element using the calibration curve method for the relevant metal species. Alternatively, an FIB cross-section of the component can be observed with a scanning microscope to measure the thickness from an actual observation image.

In a case of forming the first thin film layer 26a and the second thin film layer 26b by a thin film formation method, these thin film layers may include metals such as Cu, Cr, Au, Pt, Ag, Sn, Ti, or Ni.

The first thin film layer 26a and the second thin film layer 26b may be formed taking into consideration their respective functions. For example, in consideration of adhesion with the multilayer body 12, NiCr or NiCu is preferably used as the main component. Alternatively, the first thin film layer 26a and the second thin film layer 26b may include a plurality of layers, or may have a two-layer structure of NiCr and NiCu.

The thin film layer 26 may be formed by screen printing, CVD, ALD, or the like, and contain a dielectric material and a metal component. These methods can further improve the fixing strength between the multilayer body and the outer electrode by fixing the thin film layer 26 and the ceramic of the multilayer body 12. In this case, the thin film layer 26 may have a discontinuous shape. The term “discontinuous” means that the thin film layer is formed discontinuously as viewed from a direction perpendicular to the longitudinal direction.

For example, in a case of forming the thin film layer 26 from a ceramic-including material, one method is to polish the cross-section and then take a sectional image using a digital microscope (Keyence Corporation: VHX-5000) to calculate the thickness from the sectional image. Another method is to measure the thickness or other parameters from an FIB sectional image of the component actually observed with a scanning microscope.

In a case where the first thin film layer 26a and the second thin film layer 26b each include the same main component as the dielectric layer 14, the adhesion can be further improved by simultaneously firing the multilayer body 12 with the first thin film layer 26a and the second thin film layer 26b. In this case, the metal component is preferably Ni, Cu, or the like, but can be changed as appropriate depending on the metal component of the inner electrode layer 16.

The plating layer 30 includes a first plating layer 30a and a second plating layer 30b.

The first plating layer 30a covers the first thin film layer 26a and the first end surface 12e of the multilayer body 12.

The second plating layer 30b covers the second thin film layer 26b and the second end surface 12f of the multilayer body 12.

The plating layer 30 includes a plurality of layers. Specifically, the plating layer 30 includes an upper plating layer 34 and a surface plating layer 36.

The upper plating layer 34 includes a first upper plating layer 34a included in the first plating layer 30a and a second upper plating layer 34b included in the second plating layer 30b. The surface plating layer 36 includes a first surface plating layer 36a included in the first plating layer 30a and a second surface plating layer 36b included in the second plating layer 30b.

The first upper plating layer 34a of the upper plating layer 34 covers a first direct plating layer 28a of a direct plating layer 28 and the first thin film layer 26a.

The second upper plating layer 34b of the upper plating layer 34 covers a second direct plating layer 28b of the direct plating layer 28 and the second thin film layer 26b.

The upper plating layer 34 is preferably Ni plating to reduce solder corrosion.

The first surface plating layer 36a of the surface plating layer 36 covers the first upper plating layer 34a of the upper plating layer 34.

The second surface plating layer 36b of the surface plating layer 36 covers the second upper plating layer 34b of the upper plating layer 34.

The surface plating layer 36 is preferably Sn plating with good bonding strength with solder used to mount of the multilayer ceramic capacitor 10. The surface plating layer 36 may also be Cu plating. In this case, the bonding strength with vias formed when the multilayer ceramic capacitor 10 is embedded in a mounting substrate can be improved.

The plating layer 30 may also include the surface plating layer 36 alone. In this case, the first surface plating layer 36a of the surface plating layer 36 covers the first thin film layer 26a, and the second surface plating layer 36b of the surface plating layer 36 covers the second thin film layer 26b.

The metal content per unit volume of the plating layer 30 is preferably more than or equal to about 99 volume %, for example.

The thickness per layer of the plating layer 30 is preferably about 1.0 μm to about 10.0 μm, inclusive, for example.

It is assumed that the dimension in the length direction z of the multilayer ceramic capacitor 10, including the multilayer body 12, the first outer electrode 24a, and the second outer electrode 24b, is the L dimension, the dimension in the height direction x of the multilayer ceramic capacitor 10, including the multilayer body 12, the first outer electrode 24a, and the second outer electrode 24b, is the T dimension, and the dimension in the width direction y of the multilayer ceramic capacitor 10, including the multilayer body 12, the first outer electrode 24a, and the second outer electrode 24b, is the W dimension.

It is preferable that the dimensions of the multilayer ceramic capacitor 10 be such that the L dimension in the length direction z is about 0.1 mm to about 1.6 mm, inclusive, the T dimension in the height direction x is about 10 μm to about 100 μm, inclusive, and the W dimension in the width direction y is about 0.1 mm to about 1.6 mm, inclusive, for example. In the multilayer ceramic capacitor 10 illustrated in FIG. 1, the L dimension is greater than the W dimension.

In this example embodiment, the effects of the present invention can be effectively achieved when the T dimension in the height direction x of the multilayer ceramic capacitor 10 is less than or equal to about 100 μm, and are even more effective when the T dimension in the height direction x of the multilayer ceramic capacitor 10 is less than or equal to about 55 μm, or less than or equal to about 50 μm, for example.

In the multilayer ceramic capacitor 10 according to the first example embodiment illustrated in FIG. 1, the inclination angle θ₁ between the first inclined portion 40₁ and the line parallel to the length direction z is different from the inclination angle θ₂ between the second inclined portion 42₁ and the line parallel to the length direction z, as illustrated in FIG. 3. This allows stress near the intersection of the second main surface 12b and the first end surface 12e and stress near the intersection of the second main surface 12b and the second end surface 12f, where the outer electrode 24 is easily peeled off from the multilayer body 12 upon mounting with the first main surface 12a as the mounting surface, to be dispersed to the vicinity of the inclined portions, thus achieving the effect of reducing or preventing the peeling of the outer electrode 24.

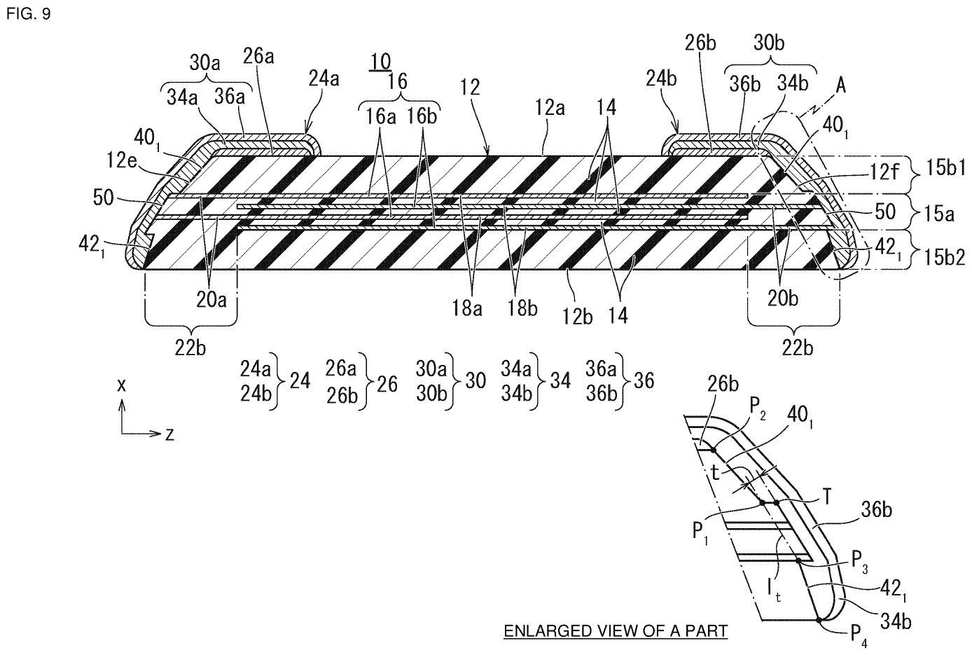

Next, an example of a multilayer ceramic capacitor 10A according to a first modification of the first example embodiment of the present invention will be described. FIG. 9 is a schematic sectional view illustrating an example of the multilayer ceramic capacitor according to the first modification of the first example embodiment of the present invention. Note, however, that components identical or corresponding to those in FIGS. 1 to 8 will be denoted by the same reference numerals, and detailed description thereof will be omitted.

As illustrated in FIG. 9, the multilayer ceramic capacitor 10A according to the first modification includes an inner electrode layer 16 exposed at a first end surface 12e or a second end surface 12f in an inner layer portion 15a, and dielectric layers 14 laminated alternately with the inner electrode layer 16.

As illustrated in FIG. 9, a first inclined portion 40₁ is included in a first main surface-side outer layer portion 15b1 provided on the first main surface 12a side at the first end surface 12e and the second end surface 12f, and a second inclined portion 42₁ is included in a second main surface-side outer layer portion 15b2 at the first end surface 12e and the second end surface 12f.

Here, the first inclined portion 40₁ is the region on the first end surface 12e from an intersection P₁ between the inner layer portion 15a and the first main surface-side outer layer portion 15b1 to an intersection P₂ between the first main surface 12a and the first end surface 12e. The second inclined portion 42₁ is the region on the first end surface 12e from an intersection P₃ between the inner layer portion 15a and the second main surface-side outer layer portion 15b2 to an intersection P₄ between the second main surface 12b and the first end surface 12e.

In this case, as illustrated in FIG. 9, the inner layer portion 15a includes a projecting portion 50 protruding from a line l₃ connecting the intersection P₁ and the intersection P₂ and have a shape substantially perpendicular to the first end surface 12e. Similarly, the inner layer portion 15a includes a projecting portion 50 protruding from and having a shape substantially perpendicular to the second end surface 12f. Here, the protruding inner layer portion 15a is structured such that both the inner electrode layer 16 and the dielectric layer 14 protrude. In this case, the protrusion amount of the inner electrode layer 16 may be different from the protrusion amount of the dielectric layer 14. If the protrusion amount of the inner electrode layer 16 is greater, the portion of the dielectric layer 14 is recessed, resulting in an uneven shape.

A protrusion amount t of the inner layer portion 15a from a line lₜ connecting the intersection P₁ and the intersection P₂ is the shortest distance between a vertex T of the projecting portion 50a and the line lₜ. The protrusion amount t of the inner layer portion 15a is preferably about 0.3 μm to about 3.0 μm, inclusive, for example. When the protrusion amount t of the inner layer portion 15a is within this range, the surface shape does not become too smooth and the surface area of the inner layer portion 15a increases. Thus, the fixing strength between the multilayer body 12 and the outer electrode 24 can be further improved.

If the intersection between the first main surface 12a and the first end surface 12e and the intersection between the second main surface 12b and the first end surface 12e are rounded, making the intersection P₂ unclear, the first inclined portion 40₁ is defined as a line from a point on the first end surface 12e that is located about 2 μm away in the lamination direction from the inner electrode layer 16 closest to the first main surface 12a toward the first main surface 12a to the intersection P₁ between the inner layer portion 15a and the first main surface-side outer layer portion 15b1. The second inclined portion 42₁ is defined as a line from a point on the first end surface 12e that is located about 2 μm away in the lamination direction from the inner electrode layer 16 closest to the second main surface 12b toward the second main surface 12b to the intersection P₃ between the inner layer portion 15a and the second main surface-side outer layer portion 15b2.

In this case, the inclination angle of each inclined portion is defined by the angle between the intersection and the line parallel to the length direction z.

The inner layer portion 15a on the first end surface 12e may also be provided with an inclined portion, and in that case, the exposed surface of the inner electrode layer 16 may also be inclined. Similarly, the inner layer portion 15a on the second end surface 12f may also be provided with an inclined portion, and in that case, the exposed surface of the inner electrode layer 16 may also be inclined.

The multilayer ceramic capacitor 10A according to the first modification of the first example embodiment illustrated in FIG. 9 achieves the same effects as the multilayer ceramic capacitor 10 described above, as well as the following effect.

Specifically, the projecting portions of the inner layer portion 15a or the uneven surface of the inner layer portion 15a increases the surface area of the metal component and the dielectric component, and therefore increases the contact area between the metal component in the outer electrode and the metal component of the multilayer body 12. Thus, the fixing strength between the multilayer body 12 and the outer electrode 24 can be further improved.

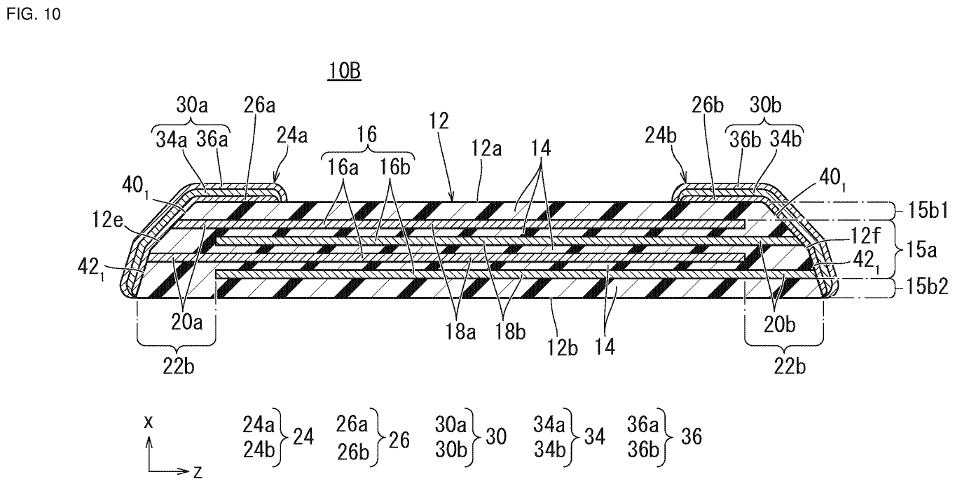

Next, an example of a multilayer ceramic capacitor 10B according to the second modification of the first example embodiment of the present invention will be described. FIG. 10 is a schematic sectional view illustrating an example of the multilayer ceramic capacitor according to the second modification of the first example embodiment of the present invention. Note, however, that components identical or corresponding to those in FIGS. 1 to 8 will be denoted by the same reference numerals, and detailed description thereof will be omitted.

In the multilayer ceramic capacitor 10B according to the second modification, as illustrated in FIG. 10, a first thin film layer 26a and a second thin film layer 26b are each formed so as to wrap around to a first end surface 12e and a second end surface 12f of the multilayer body 12.

Specifically, the first thin film layer 26a is formed so as to wrap around and cover the first end surface 12e from the first main surface 12a. The second thin film layer 26b is also formed so as to wrap around and cover the second end surface 12f from the first main surface 12a.

The first thin film layer 26a is directly electrically connected to a first extended electrode portion 20a of a first inner electrode layer 16a exposed from the first end surface 12e. The second thin film layer 26b is directly electrically connected to a second extended electrode portion 20b of a second inner electrode layer 16b exposed from the second end surface 12f.

The first thin film layer 26a may be formed so that a thin film layer formed on the first main surface 12a and a thin film layer formed on the first end surface 12e are continuously connected, or may be formed discontinuously at a ridge portion. Similarly, the second thin film layer 26b may be formed so that a thin film layer formed on the first main surface 12a and a thin film layer formed on the second end surface 12f are continuously connected, or may be formed discontinuously at a ridge portion.

The multilayer ceramic capacitor 10B according to the first example embodiment illustrated in FIG. 10 achieves the same effects as the multilayer ceramic capacitor 10 described above, as well as the following effect.

Specifically, since the first thin film layer 26a is located on the first end surface 12e and the second thin film layer 26b is located on the second end surface 12f, the first inclined portion 40₁ and the second inclined portion 42₁ increase the contact area between the metal component in the multilayer body 12 and the metal component of the thin film layer 26, and also increase the contact area between the dielectric component in the multilayer body 12 and the dielectric component in the thin film layer 26. As a result, the fixing strength between the multilayer body 12 and the outer electrode 24 can be further improved.

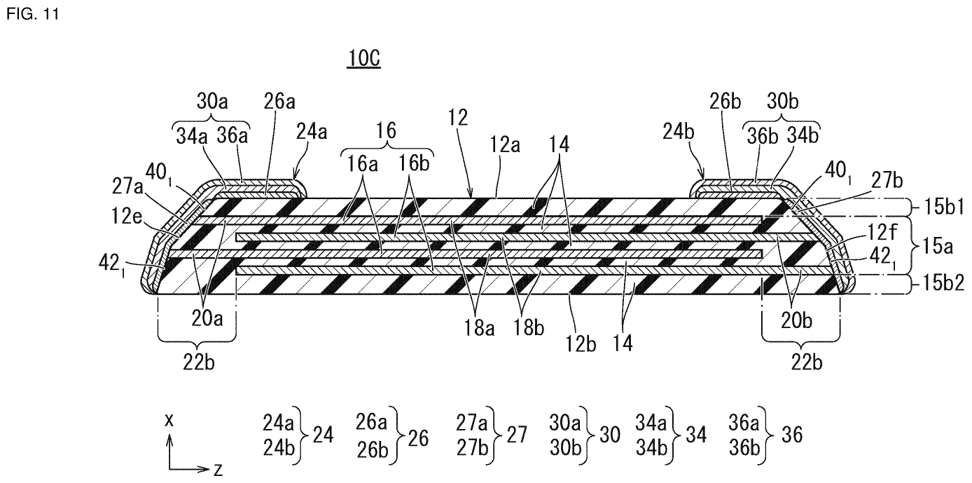

Next, an example of a multilayer ceramic capacitor 10C according to a third modification of the first example embodiment of the present invention will be described. FIG. 11 is a schematic sectional view illustrating an example of the multilayer ceramic capacitor according to the third modification of the first example embodiment of the present invention. Note, however, that components identical or corresponding to those in FIGS. 1 to 8 will be denoted by the same reference numerals, and detailed description thereof will be omitted.

As illustrated in FIG. 11, an underlying electrode layer 27 is located on both end surfaces 12e and 12f of the multilayer ceramic capacitor 10C according to the third modification of the first example embodiment.

The underlying electrode layer 27 includes a first underlying electrode layer 27a and a second underlying electrode layer 27b.

The first underlying electrode layer 27a covers the first end surface 12e of the multilayer body 12. The first underlying electrode layer 27a is electrically connected directly to the first extended electrode portion 20a of the first inner electrode layer 16a.

The first underlying electrode layer 27a may have its upper end overlapping the lower side of the first thin film layer 26a on the ridge portion defined by the first main surface 12a and the first end surface 12e of the multilayer body 12.

The second underlying electrode layer 27b covers the second end surface 12f of the multilayer body 12. The second underlying electrode layer 27b is electrically connected directly to the second extended electrode portion 20b of the second inner electrode layer 16b.

The second underlying electrode layer 27b may have its upper end overlapping the lower side of the second thin film layer 26b on the ridge portion formed by the first main surface 12a and the second end surface 12f of the multilayer body 12.

Note that the first thin film layer 26a may be partially wrapping around to the first end surface 12e, and the second thin film layer 26b may be partially wrapping around to the second end surface 12f.

The underlying electrode layer 27 includes a baked layer, for example.

In this case, the baked layer includes a metal component and a glass component. The glass component of the baked layer includes at least one selected from B, Si, Ba, Mg, Al, Li, and the like. The metal component of the baked layer includes, for example, at least one selected from Cu, Ni, Ag, Pd, Ag-Pd alloy, Au, and the like. The baked layer is formed by applying a conductive paste including glass and metal to the multilayer body and baking the conductive paste. The baked layer is formed by co-firing a multilayer chip having the inner electrode layer 16 and the dielectric layer 14 with a conductive paste applied to the multilayer chip. Alternatively, the baked layer may be formed by firing the multilayer chip having the inner electrode layer 16 20 and the dielectric layer 14, followed by baking. The baked layer may include a plurality of layers.

The thickness per layer of the underlying electrode layer 27 is preferably about 0.1 μm to about 200 μm, inclusive, for example.

The first underlying electrode layer 27a and the second underlying electrode layer 27b may have their upper ends spaced apart from the first thin film layer 26a and the second thin film layer 26b, respectively.

The multilayer ceramic capacitor 10C according to the first example embodiment illustrated in FIG. 11 achieves the same effects as the multilayer ceramic capacitor 10 described above, as well as the following effect.

Specifically, the first underlying electrode layer 27a is located on the first end surface 12e, and the second underlying electrode layer 27b is located on the second end surface 12f. This increases the surface areas of the metal component and the dielectric component in the first inclined portion 40₁ and the second inclined portion 42₁. Accordingly, the contact area between the metal component in the multilayer body 12 and the metal component of the underlying electrode layer 27 increases. Also, the contact area between the dielectric component in the multilayer body 12 and the glass component in the underlying electrode layer 27 increases. As a result, the fixing strength between the multilayer body 12 and the outer electrode 24 can be further improved.

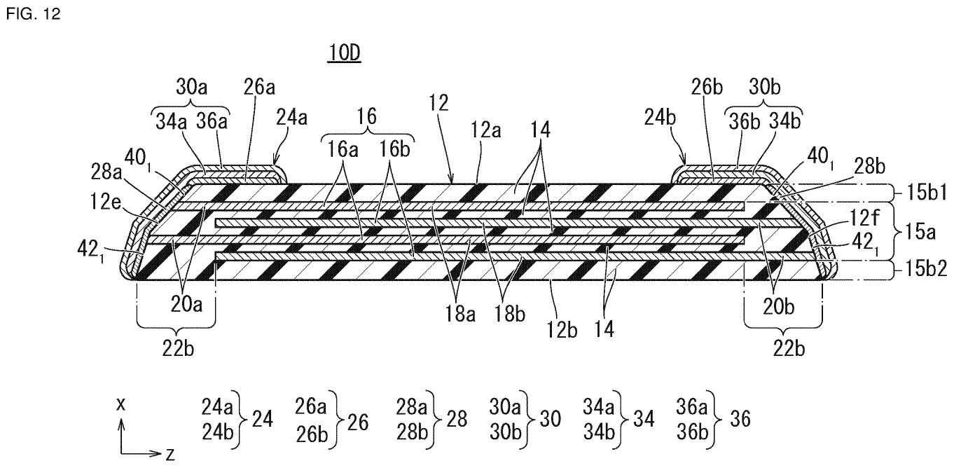

Next, an example of a multilayer ceramic capacitor 10D according to a fourth modification of the first example embodiment of the present invention will be described. FIG. 12 is a schematic sectional view illustrating an example of the multilayer ceramic capacitor according to the fourth modification of the first example embodiment of the present invention. Note, however, that components identical or corresponding to those in FIGS. 1 to 8 will be denoted by the same reference numerals, and detailed description thereof will be omitted.

As illustrated in FIG. 12, a direct plating layer 28 is located on both end surfaces 12e and 12f of the multilayer ceramic capacitor 10D according to the fourth modification of the first example embodiment.

The direct plating layer 28 includes a first direct plating layer 28a and a second direct plating layer 28b.

The first direct plating layer 28a covers the first end surface 12e of the multilayer body 12. The first direct plating layer 28a is electrically connected directly to the first extended electrode portion 20a of the first inner electrode layer 16a.

The first direct plating layer 28a has its upper end overlapping the lower side of the first thin film layer 26a on the ridge portion defined by the first main surface 12a and the first end surface 12e of the multilayer body 12.

The second direct plating layer 28b covers the second end surface 12f of the multilayer body 12. The second direct plating layer 28b is electrically connected directly to the second extended electrode portion 20b of the second inner electrode layer 16b.

The second direct plating layer 28b has its upper end overlapping the lower side of the second thin film layer 26b on the ridge portion defined by the first main surface 12a and the second end surface 12f of the multilayer body 12.

Note that the first direct plating layer 28a may be partially wrapping around to the second main surface 12b, and the second direct plating layer 28b may be partially wrapping around to the second main surface 12b.

The direct plating layer 28 is not particularly limited as long as at least one metal selected from the group consisting of Cu, Ni, Ag, Pd, Ag-Pd alloy, Au, and the like, for example, is included as its main metal component. For example, if the first inner electrode layer 16a and the second inner electrode layer 16b include Ni, Cu plating having good bondability with Ni is preferably used for the direct plating layer 28.

The direct plating layer 28 is formed by plating growing from the inner electrode layer 16, so as to cover the first end surface 12e and the second end surface 12f.

The thickness per layer of the direct plating layer 28 is preferably about 2.0 μm to about 10.0 μm, inclusive, for example.

The first direct plating layer 28a and the second direct plating layer 28b may have their upper ends spaced apart from the first thin film layer 26a and the second thin film layer 26b, respectively.

Accordingly, the thickness of the outer electrode 24 on the first main surface 12a in the lamination direction can be further reduced, thus making it possible to provide a multilayer ceramic capacitor with further reduced height without impairing mountability upon mounting.

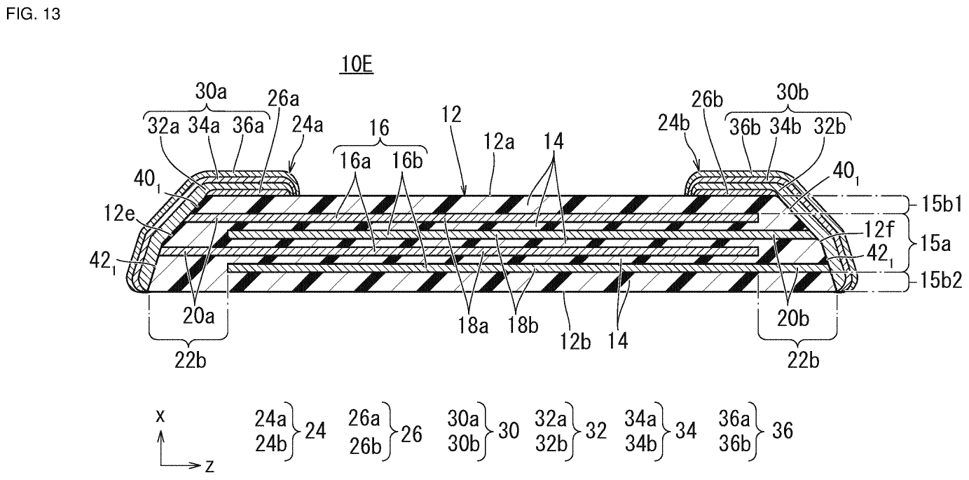

Next, an example of a multilayer ceramic capacitor 10E according to a fifth modification of the first example embodiment of the present invention will be described. FIG. 13 is a schematic sectional view illustrating an example of the multilayer ceramic capacitor according to the fifth modification of the first example embodiment of the present invention. Note, however, that components identical or corresponding to those in FIGS. 1 to 8 will be denoted by the same reference numerals, and detailed description thereof will be omitted.

As illustrated in FIG. 13, in the multilayer ceramic capacitor 10E according to the fifth modification, the plating layer 30 of the outer electrode 24 further includes a lower plating layer 32 between the thin film layer 26 and the upper plating layer 34. As a result, the upper plating layer 34 of the plating layer 30 indirectly covers the thin film layer 26 with the lower plating layer 32 interposed therebetween.

With such a configuration, the lower plating layer 32 can block moisture from entering the multilayer ceramic capacitor 10E from the outside.

The multilayer ceramic capacitor 10E according to the fifth modification illustrated in FIG. 13 achieves the same effects as the multilayer ceramic capacitor 10 illustrated in FIG. 1. The multilayer ceramic capacitor 10E according to the fifth modification can also reduce or prevent moisture intrusion from the outside.

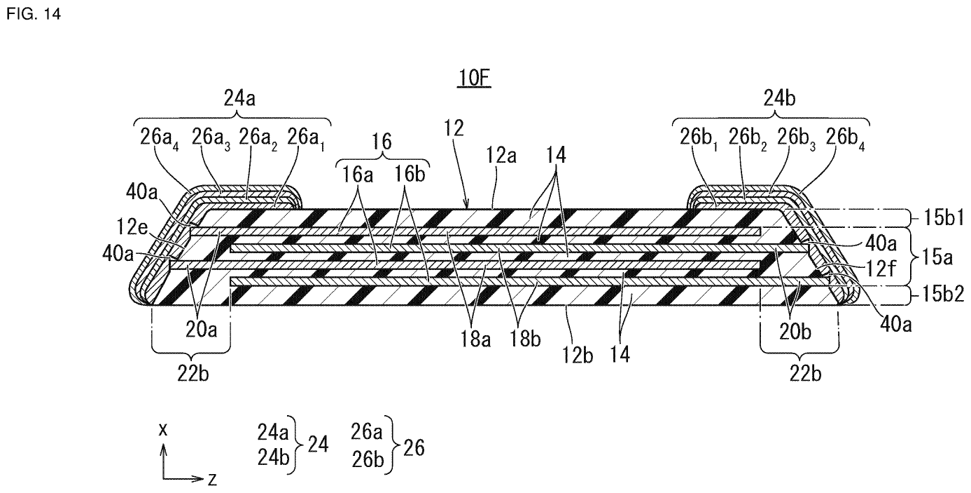

Next, a multilayer ceramic capacitor 10F according to a sixth modification of the first example embodiment of the present invention will be described. FIG. 14 is a schematic sectional view illustrating an example of the multilayer ceramic capacitor according to the sixth modification of the first example embodiment of the present invention. Note, however, that components identical or corresponding to those in FIGS. 1 to 8 will be denoted by the same reference numerals, and detailed description thereof will be omitted.

The outer electrode 24 of the multilayer ceramic capacitor 10F according to the sixth modification includes no plating layers, and includes a plurality of thin film layers. In the multilayer ceramic capacitor 10E illustrated in FIG. 14, for example, the first outer electrode 24a includes no plating layers and includes only four thin film layers 26a1 to 26a4, while the second outer electrode 24b includes no plating layers and includes only four thin film layers 26b1 to 26b4.

In the first outer electrode 24a, the thin film layer 26a1 wraps around and cover the first end surface 12e from the first main surface 12a. The thin film layers 26a2, 26a3, and 26a4 are then formed in this order on the surface of the thin film layer 26a1.

In the second outer electrode 24b, the thin film layer 26b1 wraps around and cover the second end surface 12f from the first main surface 12a. The thin film layers 26b2, 26b3, and 26b4 are then formed in this order on the surface of the thin film layer 26b1.

In the first outer electrode 24a, respective edge portions of the four thin film layers 26a1 to 26a4 near the center of the multilayer body 12 may be or do not have to be formed so as to cover the corresponding edge portions of the respective lower layers. Similarly, in the second outer electrode 24b, respective edge portions of the four thin film layers 26b1 to 26b4 near the center of the multilayer body 12 may be or do not have to be formed so as to cover the corresponding edge portions of the respective lower layers.

The multilayer ceramic capacitor 10F according to the sixth modification of the first example embodiment illustrated in FIG. 14 achieves the same effects as the multilayer ceramic capacitor 10 described above, as well as the following effect.

Specifically, the multilayer ceramic capacitor 10F includes no plating layers. The first outer electrode 24a only includes the thin film layers 26a1 to 26a4, and the second outer electrode 24b only includes the thin film layers 26b1 to 26b4. This makes it possible to reduce the T dimension in the height direction x and the L dimension in the length direction z, thus reducing the dimensions of the multilayer ceramic capacitor.

A non-limiting example of a method for manufacturing a multilayer ceramic capacitor as an example of the multilayer ceramic capacitor according to the first example embodiment will be described below.

First, a dielectric sheet and a conductive paste for inner electrodes are prepared. The dielectric sheet and the conductive paste for inner electrode layers contain a binder (for example, a known organic binder) and an organic solvent (for example, a known organic solvent).

Next, the conductive paste for inner electrodes is applied in a predetermined pattern onto the dielectric sheet by screen printing, gravure printing or the like, for example, to form an inner electrode pattern. As for the dielectric sheet, a dielectric sheet for outer layers without any inner electrode pattern printed thereon is also prepared.

A predetermined number of such dielectric sheets for outer layers without any inner electrode pattern formed thereon are laminated, and then the dielectric sheet with the inner electrode pattern formed thereon, corresponding to the first inner electrode layer 16a, and the dielectric sheet with the inner electrode pattern formed thereon, corresponding to the second inner electrode layer 16b are alternately laminated thereon. Finally, a predetermined number of dielectric sheets for outer layers without any inner electrode pattern formed thereon are further laminated thereon to form a multilayer sheet.

Furthermore, the multilayer sheet is pressed in the lamination direction by an isostatic press or the like to form a multilayer block.

Next, the multilayer block is cut to a specified size to cut out multilayer chips. Thereafter, wet barreling may be performed to round the corners and ridge portions of the multilayer chip.

The multilayer chip is formed into a tapered shape. Upon cutting the multilayer block into chips, a dicer cut is made using a tapered blade to form an angled end surface shape. The taper angle is between about 10° and about 80°, inclusive, for example, with a non-tapered blade having the taper angle of 0°. Since the taper angle of the blade taper does not necessarily correspond to the angle of the end surface of the cut chip, the taper angle is finely adjusted to the desired angle.

Accordingly, both side surfaces and both end surfaces are inclined so as to splay out from the first main surface side toward the second main surface side. As a result, the inner electrode pattern exposed from both end surfaces can be confirmed as seen from the first main surface side.

Next, the multilayer chip is fired to produce the multilayer body 12. The firing temperature depends on the ceramic and the material of the inner electrode layer 16, but is preferably between about 900° C. and about 1400° C., inclusive, for example.

Next, the fired multilayer chips are aligned on an adhesive tape with the first main surface side facing upward. For example, if the first main surface side faces upward, the inner electrode layer 16 can be confirmed from both end surfaces, allowing for appearance selection and alignment.

The chips are then sandblasted with an abrasive and polished at an angle perpendicular to the first main surface. During this process, the outer layer portions near the first main surface on both end surfaces are easily scraped. On the other hand, the outer layer portions near the second main surface on both end surfaces are not easily scraped because the inner electrode layers 16 exposed from the end surfaces form an umbrella. Furthermore, cutting debris from the sandblasting process is easily accumulated to reduce or prevent the scraping. Since the likelihood of scraping differs between the first main surface-side outer layer portion and the second main surface-side outer layer portion, the first inclined portion 40 and the second inclined portion 42 can be provided on both end surfaces. The first inclined portion 40 and the second inclined portion 42 can also be provided on both side surfaces. Examples of the abrasive to be used include alumina oxide abrasive, zirconia alumina abrasive, silicon carbide abrasive, and the like.

Next, after sandblasting, any cutting debris adhering to the multilayer chips is removed. Such cutting debris can be removed, for example, by blowing air onto the chips.

Then, the multilayer chips with the inclined portions are removed from the adhesive tape. In this event, with the use of a foam release sheet as the adhesive tape, for example, a plurality of multilayer chips can be removed all at once by applying heat.

Thereafter, the multilayer body 12 with the first inclined portion 40 and the second inclined portion 42 included thereon is aligned on a workbench, and a first thin film layer 26a and a second thin film layer 26b are included on the first main surface 12a by sputtering or vapor deposition.

Next, a first upper plating layer 34a is formed so as to cover the first thin film layer 26a located on a portion of the first main surface 12a of the multilayer body 12, and a first surface plating layer 36a is formed so as to cover the first upper plating layer 34a. Similarly, a second upper plating layer 34b is formed so as to cover the second thin film layer 26b located on a portion of the first main surface 12a of the multilayer body 12, and a second surface plating layer 36b is formed so as to cover the second upper plating layer 34b. Specifically, the upper plating layer 34 is Ni plating, and the surface plating layer 36 is Sn plating, which are formed by electrolytic plating or electroless plating.

In a case of forming an underlying electrode layer 27, a prepared conductive paste to be the underlying electrode layer is applied to both end surfaces of the multilayer body, forming the underlying electrode layer. The conductive paste can be applied to both end surfaces of the multilayer body by dipping, screen printing or the like. The baking temperature is preferably about 700° C. to about 900° C., inclusive, for example.

In a case of forming a direct plating layer 28, it is formed as follows.

Specifically, a first direct plating layer 28a and a second direct plating layer 28b are formed on the first end surface 12e and the second end surface 12f of the multilayer body 12, respectively. The multilayer body 12 with the direct plating layer 28 formed thereon is then heat-treated to remove residual moisture remaining in the plating film and at the interface between the multilayer body 12 and the direct plating layer 28. Thereafter, the multilayer body 12 with the direct plating layer 28 formed thereon is aligned on the workbench, and a thin film layer 26 is formed on the first main surface 12a by sputtering or vapor deposition. In a case of forming the direct plating layer 28 on the thin film layer 26, the thin film layer 26 is formed by sputtering or vapor deposition, and then the direct plating layer 28 is formed.

Next, the first upper plating layer 34a is formed so as to cover the first thin film layer 26a located on a portion of the first main surface 12a of the multilayer body 12 and the first direct plating layer 28a located on the first end surface 12e of the multilayer body 12. Similarly, the second upper plating layer 34b is formed so as to cover the second thin film layer 26b located on a portion of the first main surface 12a of the multilayer body 12 and the second direct plating layer 28b located on the second end surface 12f of the multilayer body 12. The upper plating layer 34 is Ni plating, which is formed by electrolytic plating or electroless plating.

Then, the first surface plating layer 36a is formed so as to cover the first upper plating layer 34a. Similarly, the second surface plating layer 36b is formed so as to cover the second upper plating layer 34b. The surface plating layer 36 is Sn plating, which is formed by electrolytic plating or electroless plating.

The multilayer ceramic capacitor 10 according to the first example embodiment illustrated in FIG. 1 is thus manufactured.

The method for manufacturing a multilayer ceramic capacitor according to this example embodiment can provide a multilayer ceramic capacitor with improved fixing strength between the multilayer body 12 and the outer electrode 24.

Next, an example of a multilayer ceramic capacitor 510 according to a second example embodiment of the present invention will be described.

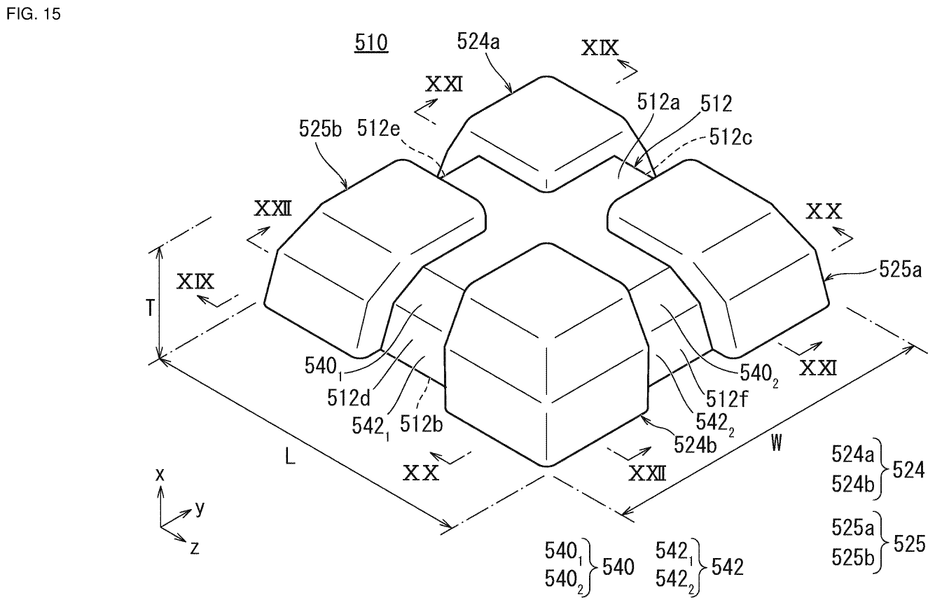

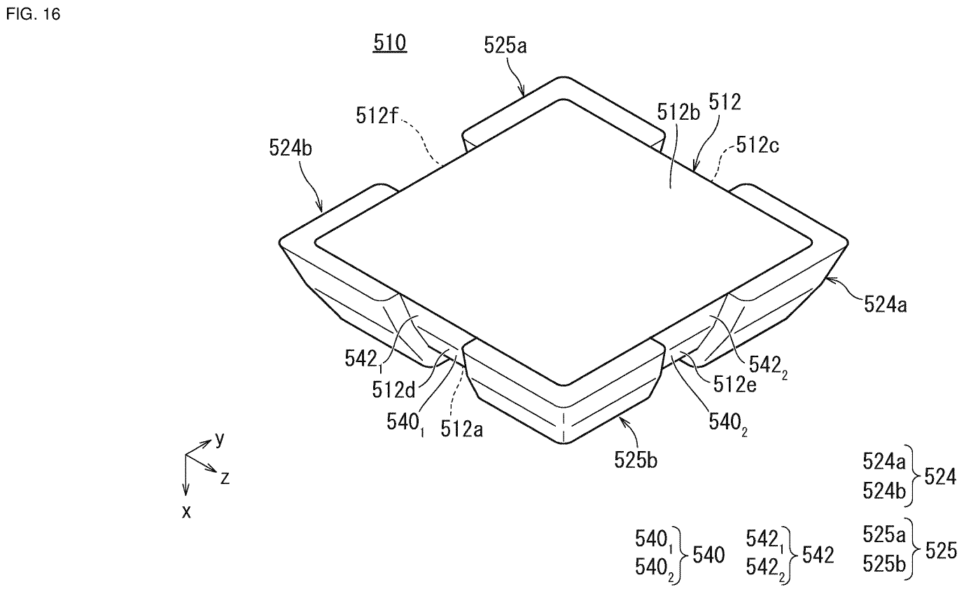

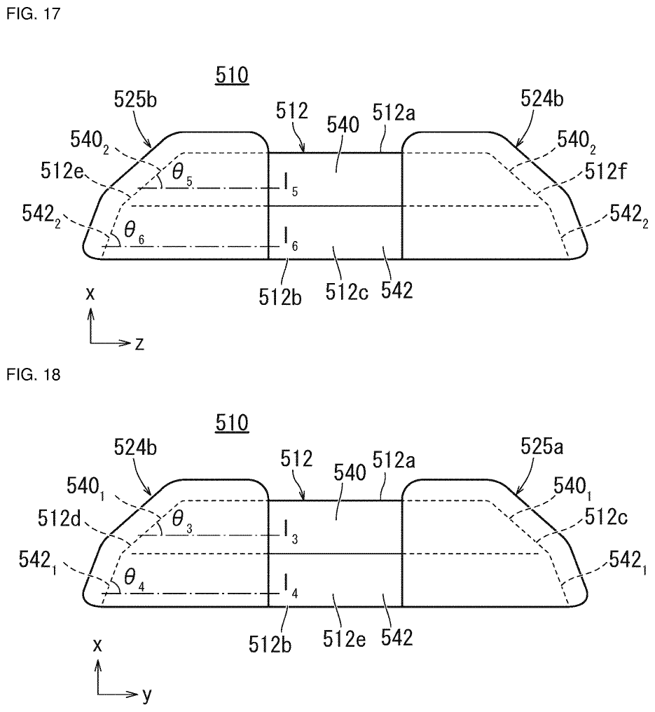

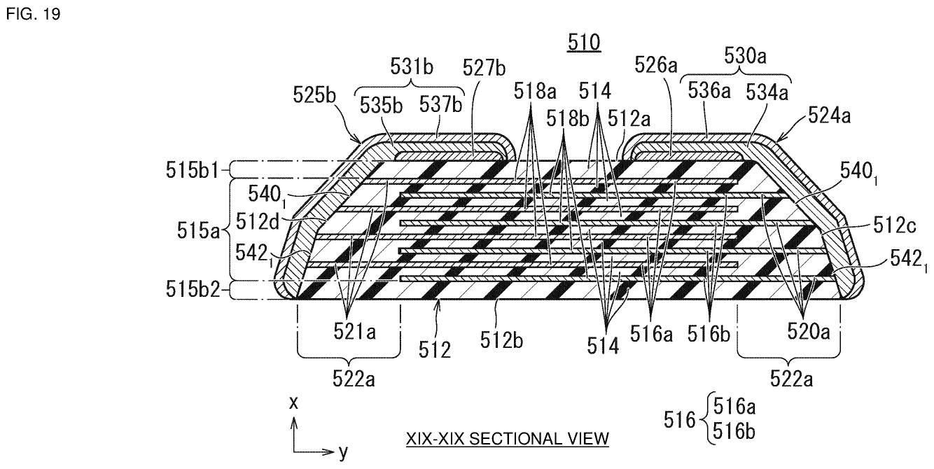

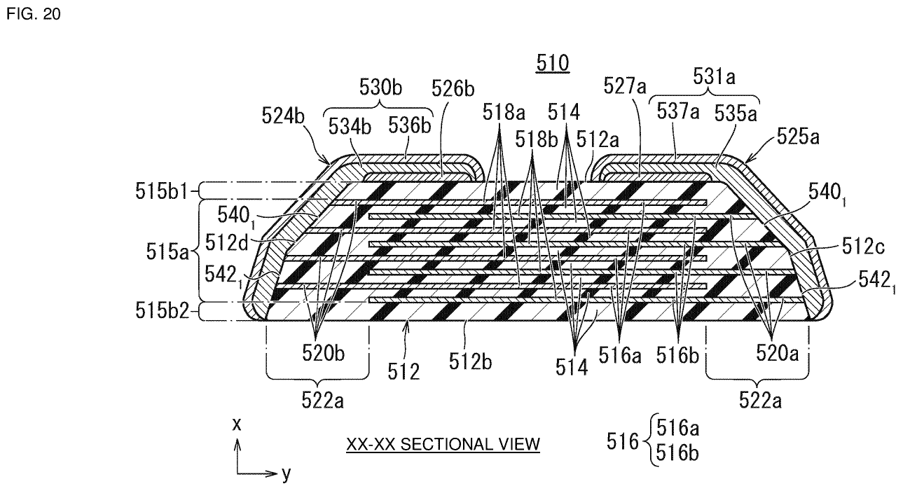

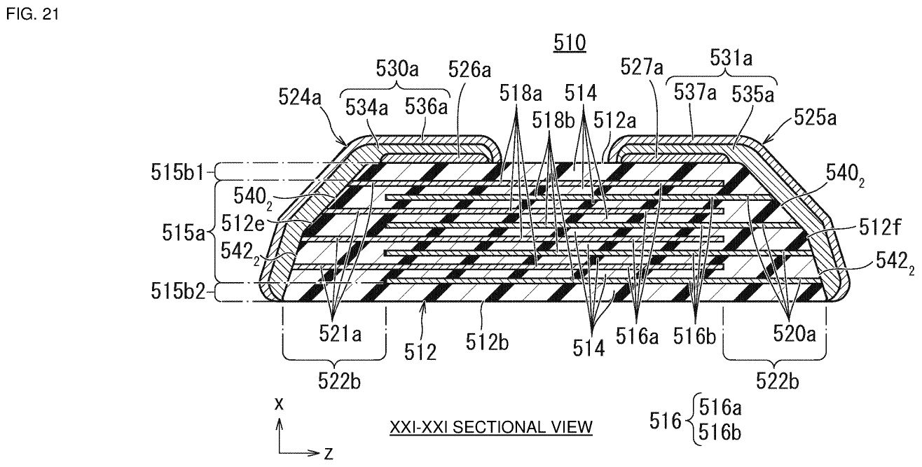

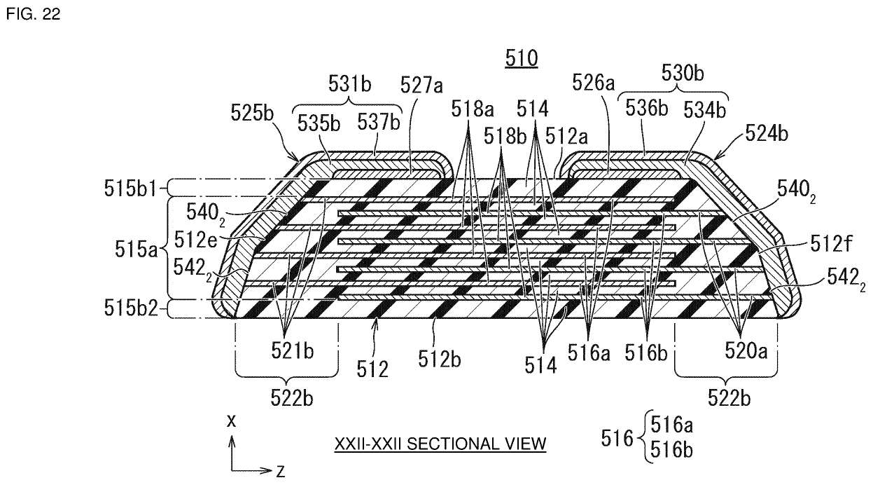

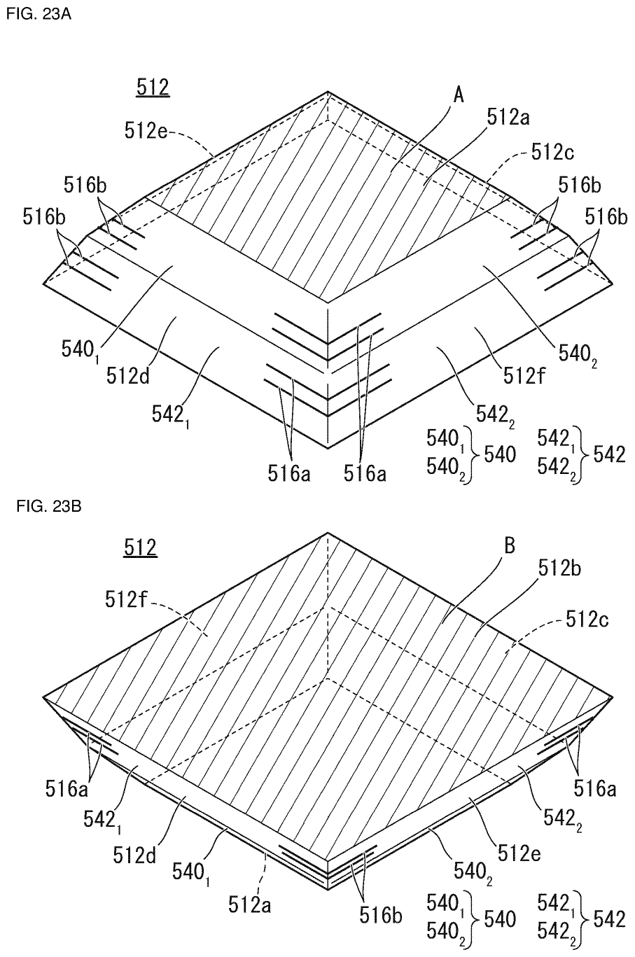

FIG. 15 is an external perspective view illustrating an example of the multilayer ceramic capacitor according to the second example embodiment of the present invention. FIG. 16 is an external perspective view illustrating an example of the multilayer ceramic capacitor according to the second example embodiment of the present invention. FIG. 17 is a front view illustrating an example of the multilayer ceramic capacitor according to the second example embodiment of the present invention. FIG. 18 is a side view illustrating an example of the multilayer ceramic capacitor according to the second example embodiment of the present invention. FIG. 19 is a schematic sectional view taken along line XIX-XIX in FIG. 15. FIG. 20 is a schematic sectional view taken along line XX-XX in FIG. 15. FIG. 21 is a schematic sectional view taken along line XXI-XXI in FIG. 15. FIG. 22 is a schematic sectional view taken along line XXII-XXII in FIG. 15. FIG. 23A is an external perspective view of a multilayer body of the multilayer ceramic capacitor according to the second example embodiment of the present invention. FIG. 23B is an external perspective view of the multilayer body as viewed from a different direction from FIG. 23A.

The multilayer ceramic capacitor 510 includes a multilayer body 512 and outer electrodes 524 and 525.

The multilayer body 512 includes a plurality of dielectric layers 514 and a plurality of inner electrode layers 516. The multilayer body 512 includes a first main surface 512a and a second main surface 512b facing each other in a height direction x, a first side surface 512c and a second side surface 512d facing each other in a width direction y orthogonal to the height direction x, and a third side surface 512e and a fourth side surface 512f facing each other in a length direction z orthogonal to the height direction x and the width direction y. The first main surface 512a and the second main surface 512b extend along the width direction y and the length direction z. The first side surface 512c and the second side surface 512d extend along the height direction x and the length direction z. The third side surface 512e and the fourth side surface 512f extend along the height direction x and the width direction y. Therefore, the height direction x is the direction connecting the first main surface 512a and the second main surface 512b. The width direction y is the direction connecting the first side surface 512c and the second side surface 512d. The length direction z is the direction connecting the third side surface 512e and the fourth side surface 512f.

The multilayer body 512 preferably has rounded corner and ridge portions. The corner portion refers to the intersection of three adjacent surfaces of the multilayer body 512. The ridge portion refers to the intersection of two adjacent surfaces of the multilayer body 512.

It is preferable that the first main surface 512a and/or the second main surface 512b be flat. A flat surface allows the stress received from a nozzle for picking up the multilayer ceramic capacitor 510 to be dispersed across the flat surface, thus improving the strength of the multilayer ceramic capacitor 510 upon mounting. The multilayer ceramic capacitor 510 according to this example embodiment includes the second main surface 512b that is flat.

As illustrated in FIGS. 18 to 21, the multilayer body 512 includes, in the height direction x connecting the first main surface 512a to the second main surface 512b, an inner layer portion 515a in which a plurality of inner electrode layers 516 face each other, a first main surface-side outer layer portion 515b1 including a plurality of dielectric layers 514 located between the first main surface 512a and the inner electrode layer 516 located closest to the first main surface 512a, and a second main surface-side outer layer portion 515b2 including a plurality of dielectric layers 514 located between the second main surface 512b and the inner electrode layer 516 located closest to the second main surface 512b.

The first main surface-side outer layer portion 515b1 and the second main surface-side outer layer portion 515b2 may become integrated after baking and cannot be distinguishable from one another, but are an aggregate of a plurality of outer dielectric layers.

The first main surface-side outer layer portion 515b1 is located on the first main surface 512a side of the multilayer body 512, and is an aggregate of a plurality of outer dielectric layers located between the first main surface 512a and the inner electrode layer 516 closest to the first main surface 512a.

The second main surface-side outer layer portion 515b2 is located on the second main surface 512b side of the multilayer body 512, and is an aggregate of a plurality of outer dielectric layers located between the second main surface 512b and the inner electrode layer 516 closest to the second main surface 512b.

The inner layer portion 515a is the region sandwiched between the first main surface-side outer layer portion 515b1 and the second main surface-side outer layer portion 515b2. The inner layer portion 515a includes a first inner electrode layer 516a, a second inner electrode layer 516b, and a dielectric layer 514.

The dielectric layer 514 can be formed of a dielectric material, for example. As the dielectric material, dielectric ceramics mainly including, for example, BaTiO₃, CaTiO₃, SrTiO₃, or CaZrO₃ can be used. Depending on the desired characteristics of the multilayer body, it is also possible to use a material including a smaller amount of subcomponent than the main component such as Mn compound, Fe compound, Cr compound, Co compound, or Ni compound.

The outer dielectric layer can include a plurality of crystal grains including a perovskite compound with a basic structure of BaTiO₃, for example. For example, dielectric ceramics mainly including BaTiO₃, CaTiO₃, SrTiO₃, CaZrO₃ or the like can be used. Alternatively, subcomponents such as Mn compound, Fe compound, Cr compound, Co compound, or Ni compound may also be added to these main components. The materials of the dielectric layer 514 and the outer dielectric layer may be different depending on the desired functions. For example, a soft outer dielectric layer can buffer stress on the multilayer body, while a hard outer dielectric layer can reduce or prevent the occurrence of cracks.

The first side surface 512c and the second side surface 512d have inclined surfaces that are inclined so as to splay out from the first main surface 512a toward the second main surface 512b. The third side surface 512e and the fourth side surface 512f also have inclined surfaces that are inclined so as to splay out from the first main surface 512a toward the second main surface 512b. As such, any two of the first side surface 512c, the second side surface 512d, the third side surface 512e, and the fourth side surface 512f of the multilayer body 512 have inclined surfaces that are inclined so as to splay out from the first main surface 512a toward the second main surface 512b.

In other words, in the multilayer body 512, the length of the first main surface 512a in the length direction z is shorter than the length of the second main surface 512b in the length direction z. Therefore, as illustrated in FIG. 17, the multilayer body 512 has a substantially trapezoidal shape in side view. Furthermore, in the multilayer body 512, the length of the first main surface 512a in the width direction y is shorter than the length of the second main surface 512b in the width direction y. Therefore, as illustrated in FIG. 18, the multilayer body 512 has a substantially trapezoidal shape in end view.

Therefore, in the multilayer body 512, if the length of the first main surface 512a in the length direction z is shorter than the length of the second main surface 512b in the length direction z and the length of the first main surface 512a in the width direction y is shorter than the length of the second main surface 512b in the width direction y, the condition A<B is satisfied in the lamination direction of the multilayer body 512, as illustrated in FIGS. 23A and 23B, where A is the area of the first main surface 512a and B is the area of the second main surface 512b.

The multilayer body 512 includes a first inclined portion 540 and a second inclined portion 542 in the inclined surface that is inclined from the first main surface 512a toward the second main surface 512b.

The first inclined portion 540 includes a first inclined portion 540₁ on the first main surface 512a side in the first side surface 512c and the second side surface 512d, and a first inclined portion 540₂ on the first main surface 512a side in the third side surface 512e and the fourth side surface 512f.

The second inclined portion 542 includes a second inclined portion 542₁ on the second main surface 512b side in the first side surface 512c and the second side surface 512d, and a second inclined portion 542₂ on the second main surface 512b side in the third side surface 512e and the fourth side surface 512f.

The first inclined portion 540₁ and the second inclined portion 542₁ are formed continuously. This can improve the adhesion between the multilayer body 512 and the outer electrodes 524 and 525, compared to a case where the first inclined portion 540₁ and the second inclined portion 542₁ are formed discontinuously. Similarly, the first inclined portion 540₂ and the second inclined portion 542₂ are also formed continuously.

Note that the first inclined portion 540₁ and the second inclined portion 542₁ may be formed discontinuously, and the first inclined portion 540₂ and the second inclined portion 542₂ may be formed discontinuously.

An inclination angle θ₃ between the first inclined portion 540₁ and a line l₃ parallel to the length direction z is different from an inclination angle θ₄ between the second inclined portion 542₁ and a line l₄ parallel to the length direction z.

This allows stress near the intersection of the second main surface 512b and the first side surface 512c and stress near the intersection of the second main surface 512b and the second side surface 512d, where the outer electrodes 524 and 525 are easily peeled off from the multilayer body 512 upon mounting with the first main surface 512a as the mounting surface, to be dispersed to the vicinity of the inclined portions, thus achieving the effect of reducing or preventing the peeling of the outer electrodes 524 and 525.

The inclination angle θ₄ between the second inclined portion 542₁ and the line l₄ parallel to the length direction z is preferably greater than the inclination angle θ₃ between the first inclined portion 540₁ and the line l₃ parallel to the length direction z.

The inclination angle θ₃ between the first inclined portion 540₁ and the line l₃ parallel to the length direction z is preferably about 30° to about 85°, inclusive, for example. If the inclination angle θ₃ is smaller than about 30°, it becomes difficult to achieve an angular difference between the inclination angle θ₃ of the first inclined portion 540₁ and the inclination angle θ₄ of the second inclined portion 542₁. On the other hand, if the inclination angle θ₃ is greater than about 85°, it becomes difficult to achieve the peeling suppression effect.

The inclination angle θ₄ between the second inclined portion 542₁ and the line l₄ parallel to the length direction z is preferably greater than the inclination angle θ₃ between the first inclined portion 540₁ and the line l₃ parallel to the length direction z by about 5° or more, for example. By making the second inclined portion 542₁ larger than the first inclined portion 540₁, a chip distance in the length direction z is shortened, making it possible to reduce the solder contraction stress acting on the electrode end portions due to the principle of leverage. On the other hand, if the difference between the inclination angle θ₄ between the second inclined portion 542₁ and the line parallel to the length direction z and the inclination angle θ₃ between the first inclined portion 540₁ and the line parallel to the length direction z is less than about 5°, it becomes difficult to achieve the peeling suppression effect.

An inclination angle θ₅ between the first inclined portion 540₂ and a line l₅ parallel to the length direction z is different from an inclination angle θ₆ between the second inclined portion 542₂ and a line l₆ parallel to the length direction z.

An inclination angle θ₆ between the second inclined portion 542₂ and a line l₆ parallel to the length direction z is preferably greater than the inclination angle θ₅ between the first inclined portion 540₂ and the line l₅ parallel to the length direction z.

The inclination angle θ₅ between the first inclined portion 540₂ and the line l₅ parallel to the length direction z is preferably about 30° to about 85°, inclusive, for example. If the inclination angle θ₅ is smaller than about 30°, it becomes difficult to achieve an angular difference between the inclination angle θ₅ of the first inclined portion 540₂ and the inclination angle θ₆ of the second inclined portion 542₂. On the other hand, if the inclination angle θ₅ is greater than about 85°, it becomes difficult to achieve the peeling suppression effect.

The inclination angle θ₆ between the second inclined portion 542₂ and the line l₆ parallel to the length direction z is preferably greater than the inclination angle θ₅ between the first inclined portion 540₂ and the line l₅ parallel to the length direction z by about 5° or more, for example. By making the second inclined portion 542₂ larger than the first inclined portion 540₂, a chip distance in the length direction z is shortened, making it possible to reduce the solder contraction stress acting on the electrode end portions due to the principle of leverage. On the other hand, if the difference between the inclination angle θ₆ between the second inclined portion 542₂ and the line parallel to the length direction z and the inclination angle θ₅ between the first inclined portion 540₂ and the line parallel to the length direction z is less than about 5°, it becomes difficult to achieve the peeling suppression effect.

The inner electrode layer 516 may be exposed at the first inclined portion 540₁. Exposing the inner electrode layer 516 at the first inclined portion 540₁ ensures close metal-to-metal contact between the inner electrode layer 516 and the outer electrodes 524 and 525, thus improving the fixing strength between the multilayer body 512 and the outer electrodes 524 and 525.

The inner electrode layer 516 may be exposed at the second inclined portion 542₁. Exposing the inner electrode layer 516 at the second inclined portion 542₁ ensures close metal-to-metal contact between the inner electrode layer 516 and the outer electrodes 524 and 525, thus improving the fixing strength between the multilayer body 512 and the outer electrodes 524 and 525.

The inner electrode layer 516 may be exposed at the first inclined portion 540₂. Exposing the inner electrode layer 516 at the first inclined portion 540₂ ensures close metal-to-metal contact between the inner electrode layer 516 and the outer electrodes 524 and 525, thus improving the fixing strength between the multilayer body 512 and the outer electrodes 524 and 525.

The inner electrode layer 516 may be exposed at the second inclined portion 542₂. Exposing the inner electrode layer 516 at the second inclined portion 542₂ ensures close metal-to-metal contact between the inner electrode layer 516 and the outer electrodes 524 and 525, thus improving the fixing strength between the multilayer body 512 and the outer electrodes 524 and 525.

The number of dielectric layers 514 to be laminated is not particularly limited, but is preferably 3 to 700, inclusive, in total, for example, including the inner layer portion 515a, the first main surface-side outer layer portion 515b1, and the second main surface-side outer layer portion 515b2. Furthermore, the inner layer portion 515a preferably has a thickness of about 0.4 μm to about 2.0 μm, inclusive, for example. The first main surface-side outer layer portion 515b1 and the second main surface-side outer layer portion 515b2 each preferably have a thickness of about 2.0 μm to about 10.0 μm, inclusive, for example.

The dielectric layer 514 can be formed of a dielectric material, for example. The dielectric material may include a plurality of crystal grains including a perovskite compound with a basic structure of BaTiO₃, for example. As a specific material of the dielectric layer 514, dielectric ceramics mainly including CaTiO₃, SrTiO₃, CaZrO₃ or the like, besides BaTiO₃, can be used. Depending on the desired characteristics of the multilayer body, it is also possible to use a material including a smaller amount of subcomponent than the main component such as Mn compound, Fe compound, Cr compound, Co compound, or Ni compound.

As illustrated in FIGS. 18 to 21, the inner electrode layer 516 includes a plurality of first inner electrode layers 516a and a plurality of second inner electrode layers 516b. The first inner electrode layers 516a and the second inner electrode layers 516b are alternately laminated with the dielectric layer 514 interposed therebetween.

The first inner electrode layer 516a is located on the surface of the dielectric layer 514. The first inner electrode layer 516a faces the first main surface 512a and the second main surface 512b, and has a first counter electrode portion 518a facing the second inner electrode layer 516b. The first inner electrode layers 516a are laminated in the direction connecting the first main surface 512a and the second main surface 512b.

The second inner electrode layer 516b is located on the surface of a different dielectric layer 514 from the dielectric layer 514 on which the first inner electrode layer 516a is provided. The second inner electrode layers 516b each have a second counter electrode portion 518b facing the first main surface 512a and the second main surface 512b, and are laminated in the direction connecting the first main surface 512a and the second main surface 512b.

As illustrated in FIGS. 18 to 21, the first inner electrode layer 516a is extended to the first side surface 512c and the third side surface 512e of the multilayer body 512 by a first extended electrode portion 520a, and is extended to the second side surface 512d and the fourth side surface 512f of the multilayer body 512 by a second extended electrode portion 520b. The width of the first extended electrode portion 520a extended to the first side surface 512c may be approximately equal to the width thereof extended to the third side surface 512e, and the width of the second extended electrode portion 520b extended to the second side surface 512d may be approximately equal to the width thereof extended to the fourth side surface 512f.

In other words, the first extended electrode portion 520a is extended to the third side surface 512e side of the multilayer body 512, and the second extended electrode portion 520b is extended to the fourth side surface 512f side of the multilayer body 512.

The second inner electrode layer 516b is extended to the first side surface 512c and the fourth side surface 512f of the multilayer body 512 by a third extended electrode portion 521a, and is extended to the second side surface 512d and the third side surface 512e of the multilayer body 512 by a fourth extended electrode portion 521b. The width of the third extended electrode portion 521a extended to the first side surface 512c may be approximately equal to the width thereof extended to the fourth side surface 512f, and the width of the fourth extended electrode portion 521b extended to the second side surface 512d may be approximately equal to the width thereof extended to the third side surface 512e.

In other words, the third extended electrode portion 521a is extended to the fourth side surface 512f side of the multilayer body 512, and the fourth extended electrode portion 521b is extended to the third side surface 512e side of the multilayer body 512.

Furthermore, when the multilayer ceramic capacitor 510 is viewed from the lamination direction, a line connecting the first extended electrode portion 520a and the second extended electrode portion 520b of the first inner electrode layer 516a preferably intersects with a line connecting the third extended electrode portion 521a and the fourth extended electrode portion 521b of the second inner electrode layer 516b.

Furthermore, on the first side surface 512c, the second side surface 512d, the third side surface 512e, and the fourth side surface 512f of the multilayer body 512, the first extended electrode portion 520a of the first inner electrode layer 516a and the fourth extended electrode portion 521b of the second inner electrode layer 516b are preferably extended to opposing positions, and the second extended electrode portion 520b of the first inner electrode layer 516a and the third extended electrode portion 521a of the second inner electrode layer 516b are preferably extended to opposing positions.

As illustrated in FIGS. 18 and 19, the multilayer body 512 includes side portions (W gaps) 522a of the multilayer body 512 between one end of the first counter electrode portion 518a in the width direction y and the first side surface 512c, and between the other end of the second counter electrode portion 518b in the width direction y and the second side surface 512d.

As illustrated in FIGS. 20 and 21, the multilayer body 512 also includes side portions (L gaps) 522b of the multilayer body 512 between one end of the first counter electrode portion 518a in the length direction z and the third side surface 512e, and between the other end of the second counter electrode portion 518b in the length direction z and the fourth side surface 512f.

The inner electrode layers 516 can be made of, but not limited to, an appropriate conductive material, such as metals such as Ni, Cu, Ag, Pd, and Au, or alloys including at least one of these metals, such as Ag-Pd alloy.

Sn included in the first inner electrode layer 516a and the second inner electrode layer 516b can alleviate the electric field concentration at the interface between the inner electrode layer 516 and the dielectric layer 514, leading to improved high-temperature load reliability. In this case, Sn can be sufficiently effective even if it is included in only one of the first inner electrode layer 516a and the second inner electrode layer 516b.

In this example embodiment, the first counter electrode portion 518a of the first inner electrode layer 516a and the second counter electrode portion 518b of the second inner electrode layer 516b face each other with the dielectric layer 514 interposed therebetween, thus generating an electrostatic capacitance and exhibiting capacitor characteristics.

In order to increase the capacitance of the capacitor, the area of the inner electrode layer 516 needs to be increased. Therefore, the inner electrode layer 516 preferably has a LW surface coverage of more than or equal to about 90%, for example. The LW surface coverage is defined as the percentage of the area inside the edge portion of the inner electrode layer 516 as viewed from the LW surface of the multilayer body 512 minus the area of any voids. The higher the LW surface coverage, the higher the capacitance of the capacitor. However, even with a lower LW surface coverage, the dielectric layers 514 are bonded with voids interposed therebetween, thus increasing the bonding strength between the layers to reduce or prevent interlayer peeling.

The outer electrodes 524 and 525 are located on the multilayer body 512, as illustrated in FIGS. 15 to 21.

The outer electrode 524 includes a thin film layer 526 and a plating layer 530 that cover the thin film layer 526.

The outer electrode 525 includes a thin film layer 527 and a plating layer 531 that cover the thin film layer 527.

The outer electrode 524 includes a first outer electrode 524a and a second outer electrode 524b.

The first outer electrode 524a covers the first extended electrode portion 520a on the first side surface 512c and the third side surface 512e, and to cover a portion of the first main surface 512a. The first outer electrode 524a is electrically connected to the first extended electrode portion 520a of the first inner electrode layer 516a.

The second outer electrode 524b covers the second extended electrode portion 520b on the second side surface 512d and the fourth side surface 512f, and to cover a portion of the first main surface 512a. The second outer electrode 524b is electrically connected to the second extended electrode portion 520b of the first inner electrode layer 516a.

The outer electrode 525 includes a third outer electrode 525a and a fourth outer electrode 525b.

The third outer electrode 525a covers the third extended electrode portion 521a on the first side surface 512c and the fourth side surface 512f, and to cover a portion of the first main surface 512a. The third outer electrode 525a is electrically connected to the third extended electrode portion 521a of the second inner electrode layer 516b.

The fourth outer electrode 525b covers the fourth extended electrode portion 521b on the second side surface 512d and the third side surface 512e, and to cover a portion of the first main surface 512a. The fourth outer electrode 525b is electrically connected to the fourth extended electrode portion 521b of the second inner electrode layer 516b.

Within the multilayer body 512, the first counter electrode portion 518a of the first inner electrode layer 516a and the second counter electrode portion 518b of the second inner electrode layer 516b face each other with the dielectric layer 514 interposed therebetween, thus generating an electrostatic capacitance. The electrostatic capacitance is thus obtained between the first and second outer electrodes 524a and 524b, to which the first inner electrode layer 516a is connected, and the third and fourth outer electrodes 525a and 525b, to which the second inner electrode layer 516b is connected, thus exhibiting the capacitor characteristics.

The thin film layer 526 includes a first thin film layer 526a and a second thin film layer 526b.

The thin film layer 527 includes a third thin film layer 527a and a fourth thin film layer 527b.

The first thin film layer 526a covers a portion of the first main surface 512a of the multilayer body 512 on the first side surface 512c side and the third side surface 512e side, but does not cover the first side surface 512c and the third side surface 512e of the multilayer body 512.

The second thin film layer 526b covers a portion of the first main surface 512a of the multilayer body 512 on the second side surface 512d side and the fourth side surface 512f side, but does not cover the second side surface 512d and the fourth side surface 512f.

The third thin film layer 527a covers a portion of the first main surface 512a of the multilayer body 512 on the first side surface 512c side and the fourth side surface 512f side, but does not cover the first side surface 512c and the fourth side surface 512f.

The fourth thin film layer 527b covers a portion of the first main surface 512a of the multilayer body 512 on the third side surface 512e side and the second side surface 512d side, but does not cover the third side surface 512e and the second side surface 512d.

The first thin film layer 526a to the fourth thin film layer 527b are preferably formed by deposition of metal particles using a method such as sputtering or vapor deposition. Accordingly, the thickness of the first thin film layer 526a to the fourth thin film layer 527b in the direction connecting the first main surface 512a and the second main surface 512b of the multilayer body 512 can be set to smaller than or equal to about 1 μm, for example, allowing the dimension in the height direction x of the multilayer ceramic capacitor 510 to be sufficiently small for height reduction of the multilayer ceramic capacitor 510.

The dimension in the height direction x of the first thin film layer 526a to the fourth thin film layer 527b can be measured as follows. Specifically, in a case of forming the thin film layers by depositing metal particles, a fluorescent X-ray apparatus can be used to obtain the thickness converted from the concentration of a specified element using the calibration curve method for the relevant metal species. Alternatively, an FIB cross-section of the component can be observed with a scanning microscope to measure the thickness from an actual observation image.

In a case of forming the first thin film layer 526a to the fourth thin film layer 527b by a thin film formation method, these thin film layers may include metals such as Cu, Cr, Au, Pt, Ag, Sn, Ti, or Ni.

The first thin film layer 526a to the fourth thin film layer 527b may be prepared taking into consideration their respective functions. For example, in consideration of adhesion with the multilayer body 512, the first thin film layer 526a to the fourth thin film layer 527b may include NiCr or the like. For example, in consideration of adhesion with the multilayer body 512, NiCr or NiCu is preferably used as the main component. Alternatively, the first thin film layer 526a to the fourth thin film layer 527b may include a plurality of layers, or may have a two-layer structure of NiCr and NiCu.

The thin film layers 526 and 527 may be formed by screen printing, CVD, ALD, or the like, and contain a dielectric material and a metal component. These methods can further improve the fixing strength between the multilayer body and the outer electrodes by fixing the thin film layer 526 and 527 and the ceramic of the multilayer body 512. In this case, the thin film layers 526 and 527 may have a discontinuous shape. The term “discontinuous” means that the thin film layers are formed discontinuously as viewed from a direction perpendicular to the longitudinal direction.

For example, in a case of forming the thin film layers 526 and 527 from a ceramic-including material, one method is to polish the cross-section and then take a sectional image using a digital microscope (Keyence Corporation: VHX-5000) to calculate the thickness from the sectional image. Another method is to measure the thickness or other parameters from an FIB sectional image of the component actually observed with a scanning microscope.

In a case where the first thin film layer 526a to the fourth thin film layer 527b each contain the same main component as the dielectric layer 514, the adhesion can be further improved by simultaneously firing the multilayer body 512 with the first to fourth thin film layers. In this case, the metal component is preferably Ni, Cu, or the like, but can be changed as appropriate depending on the metal component of the inner electrode layer 516.

The plating layer 530 includes a first plating layer 530a and a second plating layer 530b.

The first plating layer 530a covers the first thin film layer 526a and the first and third side surfaces 512c and 512e of the multilayer body 512.

The second plating layer 530b covers the second thin film layer 526b and the second and fourth side surfaces 512d and 512f of the multilayer body 512.

The plating layer 531 includes a third plating layer 531a and a fourth plating layer 531b.

The third plating layer 531a covers the third thin film layer 527a and the first and fourth side surfaces 512c and 512f of the multilayer body 512.

The fourth plating layer 531b covers the fourth thin film layer 527b and the second and third side surfaces 512d and 512e of the multilayer body 512.

The plating layers 530 and 531 each include a plurality of layers. Specifically, the plating layer 530 includes an upper plating layer 534 and a surface plating layer 536. The plating layer 531 includes an upper plating layer 535 and a surface plating layer 537.

The upper plating layer 534 includes a first upper plating layer 534a included in the first plating layer 530a and a second upper plating layer 534b included in the second plating layer 530b. The surface plating layer 536 includes a first surface plating layer 536a included in the first plating layer 530a and a second surface plating layer 536b included in the second plating layer 530b.

The upper plating layer 535 includes a third upper plating layer 535a included in the third plating layer 531a and a fourth upper plating layer 535b included in the fourth plating layer 531b. The surface plating layer 537 includes a third surface plating layer 537a included in the third plating layer 531a and a fourth surface plating layer 537b included in the fourth plating layer 531b.

The first upper plating layer 534a of the upper plating layer 534 covers the first thin film layer 526a.

The second upper plating layer 534b of the upper plating layer 534 covers the second thin film layer 526b.

The third upper plating layer 535a of the upper plating layer 535 covers the third thin film layer 527a.

The fourth upper plating layer 535b of the upper plating layer 535 covers the fourth thin film layer 527b.

The upper plating layers 534 and 535 are preferably Ni plating to reduce solder corrosion.

The first surface plating layer 536a of the surface plating layer 536 covers the first upper plating layer 534a of the upper plating layer 534.

The second surface plating layer 536b of the surface plating layer 536 covers the second upper plating layer 534b of the upper plating layer 534.

The third surface plating layer 537a of the surface plating layer 537 covers the third upper plating layer 535a of the upper plating layer 535.

The fourth surface plating layer 537b of the surface plating layer 537 covers the fourth upper plating layer 535b of the upper plating layer 535.

The surface plating layers 536 and 537 are preferably Sn plating with good bonding strength with solder used for mounting of the multilayer ceramic capacitor 510. The surface plating layers 536 and 537 may also be Cu plating. In this case, the bonding strength with vias formed when the multilayer ceramic capacitor 510 is embedded in a mounting substrate can be improved.

The plating layer 530 may include only the surface plating layer 536. In this case, the first surface plating layer 536a of the surface plating layer 536 covers the first thin film layer 526a, and the second surface plating layer 536b of the surface plating layer 536 covers the second thin film layer 526b. Similarly, the plating layer 531 may include only the surface plating layer 537. In this case, the third surface plating layer 537a of the surface plating layer 537 covers the third thin film layer 527a, and the fourth surface plating layer 537b of the surface plating layer 537 covers the fourth thin film layer 527b.

The metal content per unit volume of the plating layers 530 and 531 is preferably more than or equal to about 99 volume %, for example.

The thickness per layer of the plating layers 530 and 531 is preferably about 1.0 μm to about 10.0 μm, inclusive, for example.

It is assumed that the dimension in the length direction z of the multilayer ceramic capacitor 510, including the multilayer body 512 and the outer electrodes 524 and 525, is the L dimension, the dimension in the height direction x of the multilayer ceramic capacitor 510, including the multilayer body 512 and the outer electrodes 524 and 525, is the T dimension, and the dimension in the width direction y of the multilayer ceramic capacitor 510, including the multilayer body 512 and the outer electrodes 524 and 525, is the W dimension.

It is preferable that the dimensions of the multilayer ceramic capacitor 510 be such that the L dimension in the length direction z is about 0.1 mm to about 1.6 mm, inclusive, the T dimension in the height direction x is about 10μm to about 100 μm, inclusive, and the W dimension in the width direction y is about 0.1 mm to about 1.6 mm, inclusive, for example. The dimensions of the multilayer ceramic capacitor 510 preferably satisfy about 7/10≤L/W≤about 10/7, for example. This causes the multilayer body 512 to have a substantially tetragonal shape, thus improving the degree of freedom of mounting.

In this example embodiment, the effects of the present invention can be effectively achieved when the T dimension in the height direction x of the multilayer ceramic capacitor 510 is less than or equal to about 100 μm, and are even more effective when the T dimension in the height direction x of the multilayer ceramic capacitor 510 is less than or equal to about 55 μm, or less than or equal to about 50 μm, for example.

In the multilayer ceramic capacitor 510 illustrated in FIG. 15, the outer electrode 524 includes the first thin film layer 526a located on the first main surface 512a and the second main surface 512b of the multilayer body 512, and includes the second thin film layer 526b located on the first main surface 512a and the second main surface 512b of the multilayer body 512.

Moreover, in the multilayer ceramic capacitor 510, the outer electrode 525 includes the third thin film layer 527a located on the first main surface 512a and the second main surface 512b of the multilayer body 512, and includes the fourth thin film layer 527b located on the first main surface 512a and the second main surface 512b of the multilayer body 512.

Furthermore, in the multilayer ceramic capacitor 510, the electrical connection between the outer electrode 524 and the inner electrode layer 516 is made not using the first thin film layer 526a to the fourth thin film layer 527b, but using the plating layers 530 and 531 located on the first side surface 512c to the fourth side surface 512f.

The shape of the outer electrodes 524 and 525 may follow the outer shape of the multilayer body 512. In other words, when a first projecting portion 540a and a second projecting portion 540b are formed, the outer electrodes 524 and 525 may also have an uneven shape, as with the shapes of the first side surface 512c, the second side surface 512d, the third side surface 512e, and the fourth side surface 512f of the multilayer body 512.

The multilayer ceramic capacitor 510 according to the second example embodiment illustrated in FIG. 14 achieves the same effects as the multilayer ceramic capacitor 10.

The multilayer ceramic capacitor 510 according to the second example embodiment of the present invention may also be combined with all or part of the first to fourth modifications of the multilayer ceramic capacitor 10 according to the first example embodiment, as well as other modifications illustrated in the respective drawings.

A non-limiting example of a method for manufacturing a multilayer ceramic capacitor as an example of the multilayer ceramic capacitor according to the second example embodiment will be described below.

First, a dielectric sheet and a conductive paste for inner electrodes are prepared. The dielectric sheet and the conductive paste for inner electrode layers contain a binder (for example, a known organic binder) and a solvent (for example, a known organic solvent).

Next, the conductive paste for inner electrodes is applied in a predetermined pattern onto the dielectric sheet by screen printing, gravure printing or the like, for example, to form an inner electrode pattern. Specifically, a conductive paste layer is formed by applying a paste made of a conductive material onto the dielectric sheet using a method such as the printing method described above. The conductive paste is prepared, for example, by adding an organic binder and organic solvent to a metal powder. As for the dielectric sheet, a dielectric sheet for outer layers without any inner electrode pattern printed thereon is also prepared.

The dielectric sheet in which the inner electrode pattern corresponding to the first inner electrode layer 516a is formed, and the dielectric sheet in which the inner electrode pattern corresponding to the second inner electrode layer 516b is formed are thus prepared.

More specifically, the inner electrode layers of the present invention can be printed by separately preparing a screen plate for printing the first inner electrode layer 516a and a screen plate for printing the second inner electrode layer 516b, and using a printer capable of printing with the two types of screen plates separately.

A multilayer sheet is prepared using these dielectric sheets having the inner electrode patterns formed thereon. Specifically, a predetermined number of dielectric sheets for outer layers without any inner electrode pattern formed thereon are laminated to form a portion to be the first main surface-side outer layer portion 515b1 on the first main surface 512a side. Then, the dielectric sheet with the inner electrode pattern formed thereon, corresponding to the first inner electrode layer 516a, and the dielectric sheet with the inner electrode pattern formed thereon, corresponding to the second inner electrode layer 516b are alternately laminated thereon to form a portion to be the inner layer portion 515a. Finally, a predetermined number of dielectric sheets for outer layers without any inner electrode pattern formed thereon are further laminated thereon to form a portion to be the second main surface-side outer layer portion 515b2. Accordingly, the multilayer sheet is formed.

Furthermore, the multilayer sheet is pressed in the lamination direction by an isostatic press or the like to form a multilayer block.

Next, the multilayer block is cut to a specified size to cut out multilayer chips. Thereafter, wet barreling may be performed to round the corners and ridge portions of the multilayer chip.

The multilayer chip is formed into a tapered shape. Upon cutting the multilayer block into chips, a dicer cut is made using a tapered blade to form an angled end surface shape. The taper angle is between about 10° and about 80°, inclusive, for example, with a non-tapered blade having the taper angle of 0°, for example. Since the taper angle of the blade taper does not necessarily correspond to the angle of the end surface of the cut chip, the taper angle is finely adjusted to the desired angle.

Accordingly, all side surfaces are inclined so as to splay out from the first main surface side toward the second main surface side. As a result, the inner electrode pattern exposed from all side surfaces can be confirmed as seen from the first main surface side.

Next, the multilayer chip is fired to produce the multilayer body 512. The firing temperature depends on the ceramic and the material of the inner electrode, but is preferably between about 900° C. and about 1400° C., inclusive, for example.

Next, the fired multilayer chips are aligned on an adhesive tape with the first main surface side facing upward. For example, if the first main surface side faces upward, the inner electrode layer 516 can be confirmed from all side surfaces, allowing for appearance selection and alignment.

The chips are then sandblasted with an abrasive and polished at an angle perpendicular to the first main surface. During this process, the outer layer portions near the first main surface side on all side surfaces are easily scraped. On the other hand, the outer layer portions near the second main surface side on all side surfaces are not easily scraped because the inner electrode layers 516 exposed from all side surfaces form an umbrella. Furthermore, cutting debris from the sandblasting process is easily accumulated to reduce or prevent the scraping. Since the likelihood of scraping differs between the first main surface-side outer layer portion and the second main surface-side outer layer portion, the first inclined portion 540 and the second inclined portion 542 can be formed on all side surfaces. Examples of the abrasive to be used include alumina oxide abrasive, zirconia alumina abrasive, silicon carbide abrasive, and the like.

After sandblasting, any cutting debris adhering to the multilayer chips is removed. Such cutting debris can be removed, for example, by blowing air onto the chips.

Then, the multilayer chips with the projecting portions formed thereon are removed from the adhesive tape. In this event, with the use of a foam release sheet as the adhesive tape, for example, a plurality of multilayer chips can be removed all at once by applying heat.

Thereafter, the multilayer body 512 with the first projecting portion 540a and the second projecting portion 540b formed thereon is aligned on a workbench, and thin film layers 526 and 527 are formed on the first main surface 512a by sputtering.

Next, upper plating layers 534 and 535 and surface plating layers 536 and 537 are sequentially formed.

In other words, the first upper plating layer 534a of the upper plating layer 534 is formed so as to cover the first thin film layer 526a located on a portion of the first main surface 512a of the multilayer body 512, and the first surface plating layer 536a of the surface plating layer 536 is formed so as to cover the first upper plating layer 534a.

The second upper plating layer 534b of the upper plating layer 534 is formed so as to cover the second thin film layer 526b located on a portion of the first main surface 512a of the multilayer body 512, and the second surface plating layer 536b of the surface plating layer 536 is formed so as to cover the second upper plating layer 534b.

The third upper plating layer 535a of the upper plating layer 535 is formed so as to cover the third thin film layer 527a located on a portion of the first main surface 512a of the multilayer body 512, and the third surface plating layer 537a of the surface plating layer 537 is formed so as to cover the third upper plating layer 535a.

The fourth upper plating layer 535b of the upper plating layer 535 is formed so as to cover the fourth thin film layer 527b located on a portion of the first main surface 512a of the multilayer body 512, and the fourth surface plating layer 537b of the surface plating layer 537 is formed so as to cover the fourth upper plating layer 535b.

Specifically, the upper plating layers 534 and 535 are Ni plating, and the surface plating layers 536 and 537 are Sn plating, which are formed by electrolytic plating or electroless plating.

The multilayer ceramic capacitor 510 according to the second example embodiment illustrated in FIG. 14 is thus manufactured.

The method for manufacturing a multilayer ceramic capacitor according to this example embodiment allows for a reduction in the thickness as the T dimension in the height direction x of the outer electrodes 524 and 525 formed on the first and second main surfaces 512a and 512b. This makes it possible to provide a multilayer ceramic capacitor with reduced height without impairing mountability upon mounting.

Next, an example of a multilayer ceramic capacitor 610 according to a third example embodiment of the present invention will be described.

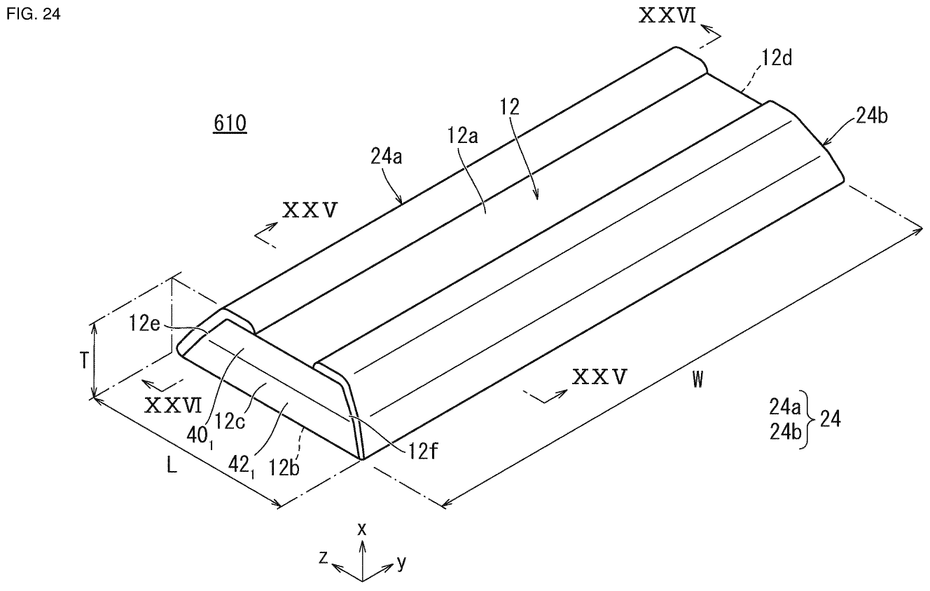

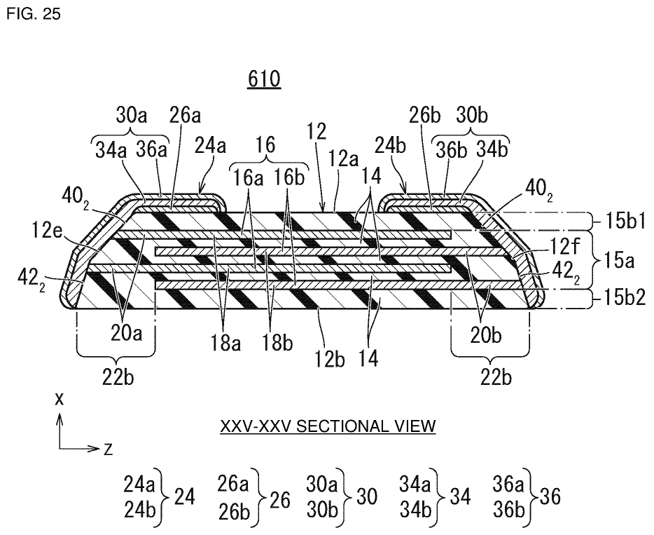

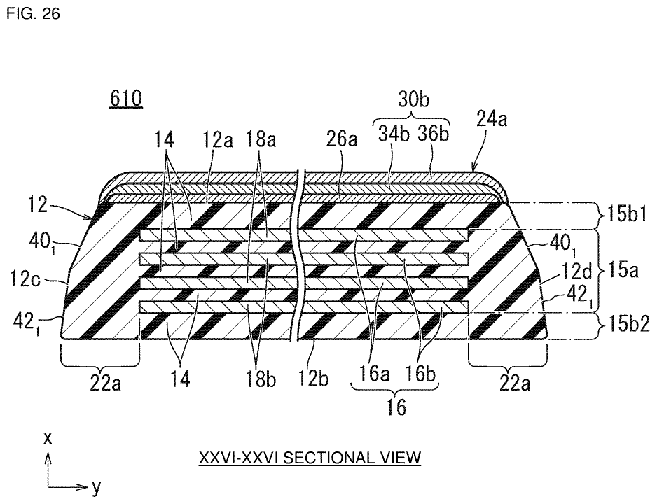

FIG. 24 is an external perspective view illustrating an example of the multilayer ceramic capacitor according to the third example embodiment of the present invention. FIG. 25 is a schematic sectional view taken along line XXV-XXV in FIG. 24, illustrating a structure of an example of the multilayer ceramic capacitor according to the third example embodiment of the present invention. FIG. 26 is a schematic sectional view taken along line XXVI-XXVI in FIG. 24, illustrating a structure of an example of the multilayer ceramic capacitor according to the third example embodiment of the present invention.

The multilayer ceramic capacitor 610 according to the third example embodiment of the present invention includes a multilayer body 12 and an outer electrode 24 having the same configurations as those of the multilayer ceramic capacitor 10 according to the first example embodiment. However, compared to the multilayer ceramic capacitor 10 according to the first example embodiment, the magnitude relationship between the L dimension and the W dimension of the multilayer ceramic capacitor 610 is reversed, with the W dimension being larger than the L dimension.

The multilayer ceramic capacitor 610 illustrated in FIG. 24 having the above configuration achieves the same effects as the multilayer ceramic capacitor 10 according to the first example embodiment.

In the multilayer ceramic capacitor according to the third example embodiment of the present invention, the outer electrode 24 of the multilayer ceramic capacitor 610 is preferably all or part of the first to fourth modifications similar to the outer electrodes 24 of the first to fourth modifications of the multilayer ceramic capacitor 10 according to the first example embodiment, or a combination of all or part thereof.

A non-limiting example of a method for manufacturing a multilayer ceramic capacitor as an example of a multilayer ceramic capacitor according to the third example embodiment will be described.

The method for manufacturing a multilayer ceramic capacitor according to the third example embodiment is the same as the method for manufacturing a multilayer ceramic capacitor according to the first example embodiment. However, the L dimension and the W dimension are interchanged compared to the multilayer ceramic capacitor 10 according to the first example embodiment.

The multilayer ceramic capacitor 610 according to the third example embodiment illustrated in FIG. 24 can thus be manufactured.

The method for manufacturing a multilayer ceramic capacitor according to this example embodiment described above can reduce the thickness of the outer electrode 24 formed on the first main surface 12a, that is, the T dimension in the height direction x. This makes it possible to provide a multilayer ceramic capacitor with further reduced height.

While the example embodiments of the present invention have been disclosed above, the present invention is not limited thereto.

Specifically, various changes can be made to the example embodiments and modifications described above in terms of mechanism, shape, material, quantity, position, arrangement, and the like, without departing from the scope of the technical ideas and purposes of example embodiments and modifications of the present invention, and such changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction;
a first outer electrode on the multilayer body; and
a second outer electrode on the multilayer body; wherein the first end surface includes an inclined surface splayed out from the first main surface toward the second main surface;
the inclined surface includes a first inclined portion on the first main surface side and a second inclined portion on the second main surface side; and
an inclination angle of the first inclined portion with respect to the length direction is different from an inclination angle of the second inclined portion with respect to the length direction.

2. The multilayer ceramic capacitor according to claim 1, wherein the inclination angle of the first inclined portion is smaller than the inclination angle of the second inclined portion.

3. The multilayer ceramic capacitor according to claim 1, wherein the multilayer body includes:
a plurality of inner electrode layers; and
at least one of the plurality of inner electrode layers is exposed at the first inclined portion.

4. The multilayer ceramic capacitor according to claim 3, wherein at least one of the plurality of inner electrode layers is exposed at the second inclined portion.

5. The multilayer ceramic capacitor according to claim 1, wherein the first inclined portion and the second inclined portion are continuous.

6. The multilayer ceramic capacitor according to claim 1, wherein the inclination angle of the first inclined portion is about 30° to about 85°, inclusive.

7. The multilayer ceramic capacitor according to claim 1, wherein the inclination angle of the second inclined portion is greater than the inclination angle of the first inclined portion by about 5° or more.

8. The multilayer ceramic capacitor according to claim 1, wherein the first side surface includes third inclined portion on the first main surface side and fourth inclined surface on the second main surface side splayed out from the first main surface toward the second main surface.

9. The multilayer ceramic capacitor according to claim 1, wherein a dimension of the multilayer body in the width direction is greater than a dimension of the multilayer body in the length direction.

10. The multilayer ceramic capacitor according to claim 1, wherein about 7/10≤L/W≤about 10/7 is satisfied, where L denotes a dimension of the multilayer ceramic capacitor in the length direction, and W denotes a dimension of the multilayer ceramic capacitor in width the direction.

11. The multilayer ceramic capacitor according to claim 8, wherein a dimension of the multilayer body in the width direction is greater than a dimension of the multilayer body in the length direction.

12. The multilayer ceramic capacitor according to claim 8, wherein about 7/10≤L/W≤about 10/7 is satisfied, where L denotes a dimension of the multilayer ceramic capacitor in the length direction, and W denotes a dimension of the multilayer ceramic capacitor in width the direction.

13. The multilayer ceramic capacitor according to claim 8, wherein the inclination angle of the first inclined portion is smaller than the inclination angle of the second inclined portion.

14. The multilayer ceramic capacitor according to claim 8, wherein the inclination angle of the third inclined portion is smaller than the inclination angle of the fourth inclined portion.

15. The multilayer ceramic capacitor according to claim 8, wherein the first inclined portion and the second inclined portion are continuous.

16. The multilayer ceramic capacitor according to claim 13, wherein a dimension of the multilayer body in the width direction is greater than a dimension of the multilayer body in the length direction.

17. The multilayer ceramic capacitor according to claim 13, wherein about 7/10≤L/W≤about 10/7 is satisfied, where L denotes a dimension of the multilayer ceramic capacitor in the length direction, and W denotes a dimension of the multilayer ceramic capacitor in width the direction.

18. The multilayer ceramic capacitor according to claim 13, wherein the inclination angle of the third inclined portion is smaller than the inclination angle of the fourth inclined portion.

19. The multilayer ceramic capacitor according to claim 13, wherein the first inclined portion and the second inclined portion are continuous.
